(19) United States
(12) Patent Application Publication
(10) Pub. No.: US 2023/0395987 A1
(43) Pub. Date: Dec. 7, 2023

(54) BASE STATION ANTENNAS HAVING AT LEAST ONE GRID REFLECTOR AND RELATED DEVICES

(71) Applicant: CommScope Technologies LLC, Hickory, NC (US)

(72) Inventors: Haifeng Li, Richardson, TX (US); Bo Wu, Suzhou (CN)

(21) Appl. No.: 18/326,239

(22) Filed: May 31, 2023

Related U.S. Application Data
(60) Provisional application No. 63/379,186, filed on Oct. 12, 2022.
(60) Provisional application No. 63/349,633, filed on Jun. 7, 2022.

(51) Int. Cl. H01Q 15/14; H01Q 1/24; H04B 7/0413

(52) U.S. Cl. CPC H01Q 15/14; H01Q 1/246; H04B 7/0413

(57) ABSTRACT

Base station antennas include at least one internal grid reflector with a feed board aperture covered by a feed board and that is configured to transmit RF energy from an array of mMIMO radiating elements through the grid reflector and out a front radome of the base station antenna while reflecting RF energy from low band and/or mid band radiating elements in a different frequency band(s) from the mMIMO radiating elements.

### RELATED APPLICATIONS

This patent application claims the benefit of and priority to U.S. Provisional Patent Application Ser. No. 63/349,633, filed Jun. 7, 2022, and U.S. Provisional Patent Application Ser. No. 63/379,186, filed Oct. 12, 2022, the contents of which are hereby incorporated by reference as if recited in full herein.

### BACKGROUND

The present invention generally relates to radio communications and, more particularly, to base station antennas for cellular communications systems.

Cellular communications systems are well known in the art. In a cellular communications system, a geographic area is divided into a series of regions that are referred to as “cells” which are served by respective base stations. The base station may include one or more antennas that are configured to provide two-way radio frequency (“RF”) communications with mobile subscribers that are within the cell served by the base station. In many cases, each cell is divided into “sectors.” In one common configuration, a hexagonally shaped cell is divided into three 120° sectors in the azimuth plane, and each sector is served by one or more base station antennas that have an azimuth Half Power Beamwidth (HPBW) of approximately 65°. Typically, the base station antennas are mounted on a tower or other raised structure, with the radiation patterns (also referred to herein as “antenna beams”) that are generated by the base station antennas directed outwardly. Base station antennas are often implemented as linear or planar phased arrays of radiating elements.

In order to accommodate the increasing volume of cellular communications, cellular operators have added cellular service in a variety of new frequency bands. In order to increase capacity without further increasing the number of base station antennas, multi-band base station antennas have been introduced which include multiple linear arrays of radiating elements. Additionally, base station antennas are now being deployed that include “beamforming” arrays that include multiple columns of radiating elements. The radios for these beamforming arrays may be integrated into the antenna so that the antenna may perform active beamforming (i.e., the shapes of the antenna beams generated by the antenna may be adaptively changed to improve the performance of the antenna). These beamforming arrays typically operate in higher frequency bands, such as various portions of the 3.3-5.8 GHz frequency band. Antennas having integrated radios that can adjust the amplitude and/or phase of the sub-components of an RF signal that are transmitted through individual radiating elements or small groups thereof are referred to as “active antennas.” Active antennas can generate narrowed beamwidth, high gain, antenna beams and can steer the generated antenna beams in different directions by changing the amplitudes and/or phases of the sub-components of RF signals that are transmitted through the antenna.

With the development of wireless communication technology, an integrated base station antenna including a passive module and an active antenna module with an active antenna has emerged. The passive module may include one or more passive arrays of radiating elements that are configured to generate relatively static antenna beams, such as antenna beams that are configured to cover a 120 degree sector (in the azimuth plane) of a base station antenna. The passive arrays may comprise arrays that operate under second generation (2G), third generation (3G) or fourth generation (4G) cellular standards. These passive arrays are not configured to perform active beamforming operations, although they typically have remote electronic tilt (RET) capabilities which allows the shape of the antenna beam to be changed via electromechanical means in order to change the coverage area of the antenna beam. The active antenna module may include one or more arrays of radiating elements that operate under fifth generation (or later) cellular standards. These arrays typically have individual amplitude and phase control over subsets of the radiating elements therein and perform active beamforming.

FIGS. 1 and 2 illustrate an example of a prior art base station antenna 10 that includes a pair of beamforming arrays and associated beamforming radios. The base station antenna 10 is typically mounted with the longitudinal axis L of the antenna 10 extending along a vertical axis (e.g., the longitudinal axis L may be generally perpendicular to a plane defined by the horizon) when the antenna 10 is mounted for normal operation. The front surface of the antenna 10 is mounted opposite the tower or other mounting structure, pointing toward the coverage area for the antenna 10. The antenna 10 includes a radome 11 and a top end cap 20. The antenna 10 also includes a bottom end cap 30 which includes a plurality of connectors 40 mounted therein. As shown, the radome 11, top cap 20 and bottom cap 30 define an external housing 10h for the antenna 10. An antenna assembly is contained within the housing 10h.

FIG. 2 illustrates that the antenna 10 can include one or more radios 50 that are mounted to the housing 10h. As the radios 50 may generate significant amounts of heat, it may be appropriate to vent heat from the active antenna in order to prevent the radios 50 from overheating. Accordingly, each radio 50 can include a (die cast) heat sink 54 that is shown mounted on the rear surface of the radio 50. The heat sinks 54 are thermally conductive and include a plurality of fins 54f. Heat generated in the radios 50 passes to the heat sink 54 and spreads to the fins 54f. As shown in FIG. 2, the fins 54f are external to the antenna housing 10h. This allows the heat to pass from the fins 54f to the external environment. Further details of example conventional base station antennas can be found in co-pending WO2019/236203 and WO2020/072880, the contents of which are hereby incorporated by reference as if recited in full herein.

Base station antennas that include active antenna units with a radio that reside behind a rear of the base station antenna have also been disclosed. See, U.S. patent application Ser. No. 17/209,562, the contents of which are also hereby incorporated by reference as if recited in full herein.

### SUMMARY

Embodiments of the present invention are directed to base station antennas with a reflector comprising a frequency selective surface (FSS) with feed board apertures. The FSS can be configured to allow high band radiating elements to propagate electromagnetic waves therethrough and reflect lower band signal from lower band radiating elements in front of the reflector.

The reflector can be a grid reflector that defines the FSS and has the feed board apertures and respective feed boards can be mounted to the grid reflector to extend across the respective feed board apertures. One or more feed stalks can be mounted to project forward and rearward of the feed board and the reflector.

Embodiments of the present invention are directed to base station antennas that include a grid reflector with a respective array of unit cells and feed stalks that project forward and rearward of the grid reflector.

The array of unit cells can be defined by conductive patches.

The array of unit cells can be defined by a pattern of shaped metal segments and apertures in sheet metal.

Embodiments of the present invention are directed to a base station antenna that includes a grid reflector having an array of unit cells and a feed board coupled to the grid reflector. The feed board is configured to replicate at least part of a unit cell structure of one or more of the unit cells of the array of unit cells.

The grid reflector can have a feed board aperture and the feed board can extend across and overlap a portion of a plurality of unit cells of the array of unit cells that surround the feed board aperture.

The feed board can have metal shapes that replicate at least part of a shape of the unit cell structure and the metal shapes can overlap at least some unit cells of the grid reflector.

The feed board can be devoid of signal transmission lines on a front primary surface.

The feed board can have a ground layer that can occupy only a portion of one primary surface of the feed board and can be arranged in at least one curvilinear metal pattern.

The base station antenna can include a radiating element with a feed stalk. The radiating element can project forward of the grid reflector. The feed board can be coupled to first and second coaxial cables that may reside adjacent a rear surface of the feed board.

The grid reflector can be at least partially defined by a metal grid with a pattern of metal unit cells. The feed board aperture can have a perimeter that is surrounded by a plurality of the unit cells.

The base station antenna can further include a plurality of spaced apart feed board apertures that are spaced apart from right and left side segments of the base station antenna. The feed board can be arranged as a plurality of spaced apart feed boards. One feed board of the plurality of feed boards can extend across one of the plurality of spaced apart feed board apertures.

The array of unit cells can be arranged in a repeating pattern that can extend across at least a major portion of a lateral dimension of the base station antenna in front an array of radiating elements.

The feed board can have at least one conductive segment that has a curvilinear configuration that matches at least a portion of at least a portion of a structure of a unit cell of the array of unit cells of the grid reflector.

The feed board aperture can have a surface area that is greater than a surface area of a unit cell of the array of unit cells.

The grid reflector can be defined at least partially by a metal grid.

The grid reflector can be defined at least partially by a multi-layer printed circuit board.

The feed board can be devoid of solid, continuous conductive primary surfaces and can have conductive segments provided in a shape that corresponds to at least a portion of a shape of one or more unit cells of an array of the unit cells.

The grid reflector can define a frequency selective surface. The grid reflector and feed board can cooperate to reflect energy in a first frequency band and allow energy from mMIMO radiating elements in a second frequency band that are positioned behind the grid reflector to propagate therethrough.

The base station antenna can further include an active antenna unit coupled to a rear of the base station antenna and can reside behind the grid reflector.

The feed board has a perimeter shape that matches at least a portion of a perimeter of at least one unit cell of the array of unit cells of the FSS.

The feed board can have a surface that has a conductive metal pattern that can match a portion of a shape of a unit cell of the array of unit cells.

The feed board can have a portion with a shape that resides over or behind a metal portion of the unit cell having a corresponding shape.

Still other aspects are directed toward a feed board for a radiating element. The feed board has first and second opposing primary surfaces and a ground layer on only one of the first and second primary surfaces. The feed board is devoid of signal transmission lines on either of the first and second primary surfaces.

The ground layer can occupy only a portion of the first or second primary surface of the feed board and can be arranged in at least one curvilinear metal pattern.

Still other aspects are directed to a base station antenna that includes: a grid reflector with an array of metal patches or metal shapes; and a feed board with spaced apart metallized shapes. At least one of the metallized shapes of the feed board overlaps with at least one of the metal patches or metal shapes of the grid reflector.

The grid reflector can have a feed board aperture and the feed board can extend across and overlap a portion of a plurality of the metal patches or the metal shapes that surround the feed board aperture.

The feed board can be devoid of signal transmission lines on a front primary surface.

The array of metal patches or metal shapes of the grid reflector can define unit cells and at least one of the metallized shapes of the feed board can have a shape that matches at least part of a unit cell of the unit cells and overlaps and covers at least part of the unit cell.

The feed board aperture can extend through a plurality of inner perimeter portions of metal shapes of the grid reflector that surround the feed board aperture.

The base station antenna can further include at least one coaxial connector behind and adjacent the grid reflector and can be coupled to a radiating element in front of the grid reflector.

The at least one coaxial connector can be orthogonal to the feed stalk.

The at least one coaxial connector can be parallel to the feed stalk.

The grid reflector and the feed board can cooperate to form a replicating array of unit cell structures configured to absorb and/or reflect RF energy in a first frequency band and pass RF energy in a second frequency band.

The grid reflector can be formed of sheet metal comprising an array of unit cells defining the metal patches or metal shapes.

The grid reflector can be formed of a multi-layer printed circuit board comprising the metal patches.

The base station antenna can further include an active antenna unit behind the grid reflector. The grid reflector can be configured to allow RF energy in at least part of a 3.2-4.1 GHz frequency band to propagate therethrough.

Yet other aspects are directed to a base station antenna that includes a grid reflector and a plurality of feed boards coupled to the grid reflector. Some of the feed boards reside on a front primary surface of the grid reflector and some of the plurality of feed boards reside on a rear primary surface of the grid reflector.

At least some of the plurality of feed boards can have a lattice body with apertures surrounded by metal linear segments defining at least first and second signal traces to respective first and second radiating elements.

At least some of the metal linear segments of the feed boards can align with metal linear segments of the grid reflector.

The base station antenna can further include first and second feed cables connected to a respective feed board of the plurality of feed boards. The first and second feed cables can extend from a respective feed board with 0-3 lateral segments and at least one longitudinally extending, linearly straight segment that can have a length that is longer than a cumulative length of the lateral segments to an end portion of the grid reflector.

A longitudinally extending, linearly straight segment of the first feed cable can extend in parallel to a longitudinally extending, linearly straight segment of the second feed cable.

One or more of the at least one longitudinally extending, linearly straight segment of the first and second feed cables can be parallel.

The feed boards on the front primary surface can be low-band feed boards and the feed boards on the second primary surface can be mid-band feed boards.

The lattice body can have a first feed cable connection that connects a conductor of a first feed cable to the first signal trace and a second feed cable connection that connects a conductor of a second feed cable to a second conductive signal trace.

The first signal trace can have a first power splitter that directs signals from the first feed cable to each of the first and second radiating elements and wherein the second signal trace can have a second power splitter that directs signals from the second feed cable to each of the first and second radiating elements.

The lattice body can have first and second shaped regions that are spaced apart and that each electrically connect to the first and second signal traces and that align with feed stalks of the first and second radiators.

The shaped regions can replicate at least part of a unit cell structure of the grid reflector.

The base station antenna can include first and second feed cables connected to a respective feed board of the plurality of feed boards, with the first and second cables for the feed boards on the front primary surface residing in front of the first and second feed cables of the feed boards on the rear surface and signal traces and/or the first and second feed cables can cross over each other in different planes thereby not requiring cross-over jumpers.

Still other aspects are directed to a base station antenna that includes a grid reflector and a plurality of feed boards coupled to the grid reflector. At least some of the plurality of feed boards have a lattice body with apertures surrounded by metal linear segments defining at least first and second conductive signal traces.

Some of the feed boards can reside on a front primary surface of the grid reflector and some of the plurality of feed boards can reside on a rear primary surface of the grid reflector.

At least some of the metal linear segments of the feed boards can align with metal linear segments of the grid reflector.

The base station antenna can further include first and second feed cables connected to a respective feed board of the plurality of feed boards. The first and second feed cables can extend from the respective feed board with 0-3 lateral segments and at least one longitudinally extending, linearly straight segment that has a length that is longer than a cumulative length of the lateral segments to an end portion of the grid reflector.

A longitudinally extending, linearly straight segment of the first feed cable can extend in parallel to a longitudinally extending, linearly straight segment of the second feed cable.

The feed boards on the front primary surface can include low-band feed boards and the feed boards on the second primary surface can include mid-band feed boards.

The lattice body further can include a first feed cable connection that connects a conductor of a first feed cable to the first signal trace and a second feed cable connection that connects a conductor of a second feed cable to a second conductive signal trace.

The first signal trace can have a first power splitter that directs signals from the first feed cable to each of the first and second radiating elements and the second signal trace can have a second power splitter that directs signals from the second feed cable to each of the first and second radiating elements.

The lattice body can have first and second shaped regions that are spaced apart and that each electrically connect to the first and second signal traces and that align with feed stalks of the first and second radiators.

The shaped regions can replicate at least part of a unit cell structure of the grid reflector.

The base station antenna can further include first and second feed cables connected to a respective feed board of the plurality of feed boards, with the first and second cables for the feed boards on the front primary surface residing in front of the first and second feed cables of the feed boards on the rear surface and signal traces and/or the first and second feed cables can cross over each other in different planes thereby not requiring cross-over jumpers.

It should be noted that various aspects of the present disclosure described for one embodiment may be included in other different embodiments, even though specific description is not made for the other different embodiments. In other words, all the embodiments and/or features of any embodiment may be combined in any manner and/or combination, as long as they are not contradictory to each other.

### BRIEF DESCRIPTION OF THE DRAWINGS

FIG. 1 is a perspective view of a prior art base station antenna.

FIG. 2 is a back view of another prior art base station antenna.

FIG. 3A is a back perspective view of an example base station antenna coupled to an active antenna module according to embodiments of the present invention.

FIG. 3B is a side, back perspective view of another example base station antenna coupled to an active antenna module according to embodiments of the present invention.

FIG. 4 is a front perspective view of an example primary reflector that can be provided in a base station antenna, such as the base station antenna shown in FIG. 3A or FIG. 3B, according to embodiments of the present invention.

FIG. 5A is a front perspective view of a portion of a reflector comprising a grid reflector for a base station antenna according to embodiments of the present invention.

FIG. 5B is a front view of the portion of the reflector comprising the grid reflector shown in FIG. 5A.

FIG. 6A is an enlarged view of a portion of an example grid reflector according to embodiments of the present invention.

FIG. 6B is an enlarged view of an example feed board with a feed stalk according to embodiments of the present invention.

FIG. 6C is an assembled view of the portion of the grid reflector and feed board shown in FIGS. 6A and 6B, respectively, according to embodiments of the present invention.

FIG. 7 is a rear view of a portion of a grid reflector comprising a radiating element and feed board according to embodiments of the present invention.

FIG. 8 is a rear view of another embodiment of a portion of a grid reflector comprising a radiating element according to embodiments of the present invention.

FIG. 9 is a rear view of another embodiment of a portion of a grid reflector comprising a radiating element according to embodiments of the present invention.

FIG. 10 is a front view of the grid reflector and feed board shown in FIG. 9 according to embodiments of the present invention.

FIG. 11A is an enlarged, front perspective view of another embodiment of a portion of a grid reflector comprising a feed board with a rear conductive layer and radiating element according to embodiments of the present invention.

FIG. 11B is an enlarged, front perspective view of another embodiment of a portion of a grid reflector comprising a feed board with front conductive layer and radiating element according to embodiments of the present invention.

FIG. 12A is a front view of a portion of a grid reflector with a plurality of spaced apart radiating elements and feed boards according to embodiments of the present invention.

FIG. 12B is a rear view of the portion of the grid reflector and components shown in FIG. 12A.

FIG. 13A is an enlarged side view of a portion of a grid reflector with a feed board and radiating element according to embodiments of the present invention.

FIG. 13B is a front, side perspective view of components shown in FIG. 13A, (without the radiating element) according to embodiments of the present invention.

FIG. 14A is a rear view of a portion of a grid reflector with a plurality of spaced apart corresponding feed board apertures and feed boards according to embodiments of the present invention.

FIG. 14B is a front schematic view of a portion of a three-dimensional grid reflector and spaced apart radiating elements and corresponding feed boards according to embodiments of the present invention.

FIG. 15 is an enlarged rear view of a sub-region of the portion of the grid reflector shown in FIG. 14A according to embodiments of the present invention.

FIG. 16 is an enlarged rear, perspective view of a feed board and feed stalk, similar to that shown in FIGS. 11A and 11B, illustrated without the grid reflector, according to embodiments of the present invention.

FIG. 17 is an enlarged rear, perspective view of a feed board and feed stalk, similar to that shown in FIGS. 13A, 13B and 15, illustrated without the grid reflector, according to embodiments of the present invention.

FIGS. 18-22 are example feed board configurations with one or more radiating elements coupled to example grid reflectors according to embodiments of the present invention.

FIG. 23 is a front, side perspective view of an antenna assembly and example grid reflector of a base station antenna according to embodiments of the present invention.

FIGS. 24A and 24B are simplified lateral section views of example base station antennas and cooperating active antenna modules according to embodiments of the present invention.

FIG. 25 is a side perspective view of a portion of a base station antenna with feed boards arranged along a grid reflector according to embodiments of the present invention.

FIG. 26 is a front view of a portion of the portion of the base station antenna shown in FIG. 25.

FIG. 27 is a side perspective view of an example feed board shown in FIG. 25.

FIG. 28 is an enlarged rear view of a portion of the feed board and grid reflector shown in FIG. 25 at a feed stalk position according to embodiments of the present invention.

FIG. 29 is an enlarged end view of an example feed board and grid reflector arrangement according to embodiments of the present invention.

FIG. 30 is a schematic illustration of an example feed board arrangement of different feed boards and grid reflector according to embodiments of the present invention.

FIG. 31 is a front, side perspective view of an antenna and feed board arrangement of a base station antenna, with an example feeding cable arrangement according to embodiments of the present invention.

FIG. 32 is an enlarged side perspective view of a portion of the device shown in FIG. 31.

FIG. 33 is a rear view of the device shown in FIG. 31.

FIG. 34 is a front, side perspective view of the device shown in FIG. 31, shown without the dipole radiators, according to embodiments of the present invention.

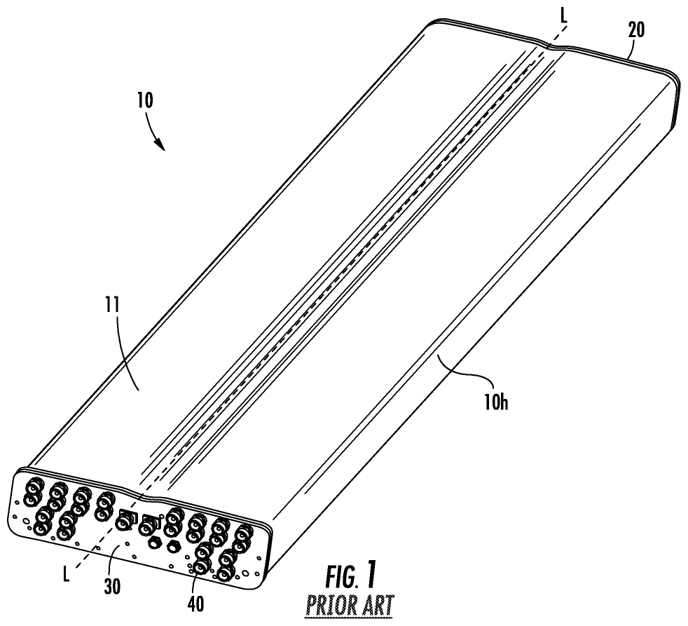

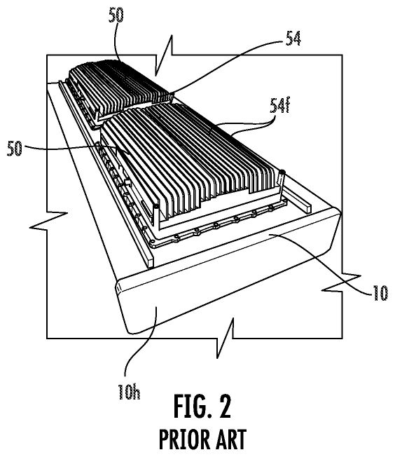

### DETAILED DESCRIPTION

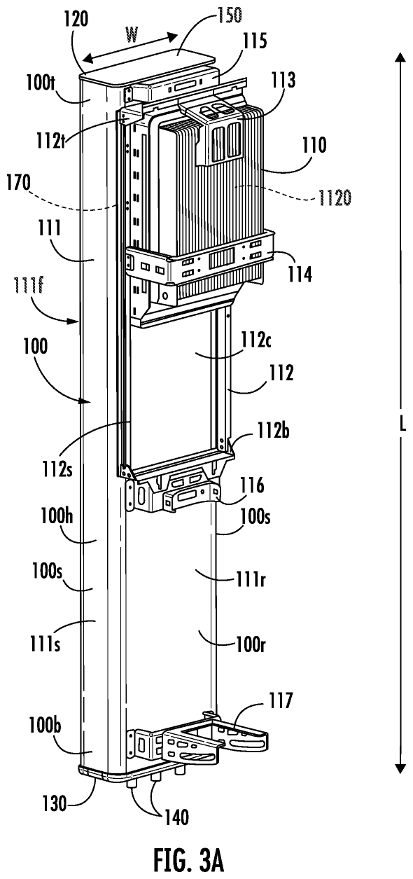

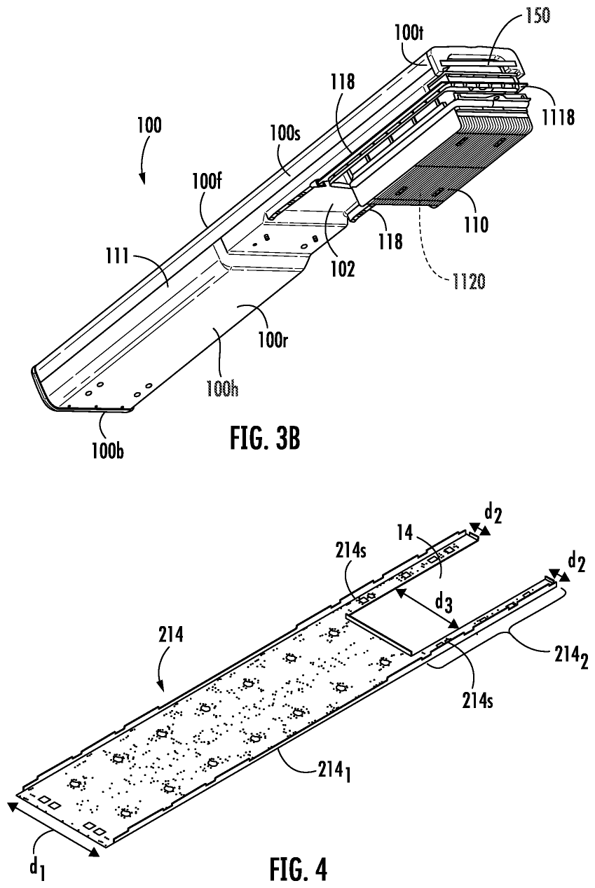

FIG. 3A illustrates a base station antenna 100 according to certain embodiments of the present invention. In the description that follows, the base station antenna 100 will be described using terms that assume that the base station antenna 100 is mounted for use on a tower, pole or other mounting structure with the longitudinal axis L of the base station antenna 100 extending along a vertical axis and the front of the base station antenna 100 mounted opposite the tower, pole or other mounting structure pointing toward the target coverage area for the base station antenna 100 and the rear 100r of the base station antenna 100 facing the tower or other mounting structure. It will be appreciated that the base station antenna 100 may not always be mounted so that the longitudinal axis L thereof extends along a vertical axis. For example, the base station antenna 100 may be tilted slightly (e.g., less than 10°) with respect to the vertical axis so that the resultant antenna beams formed by the base station antenna 100 each have a small mechanical downtilt.

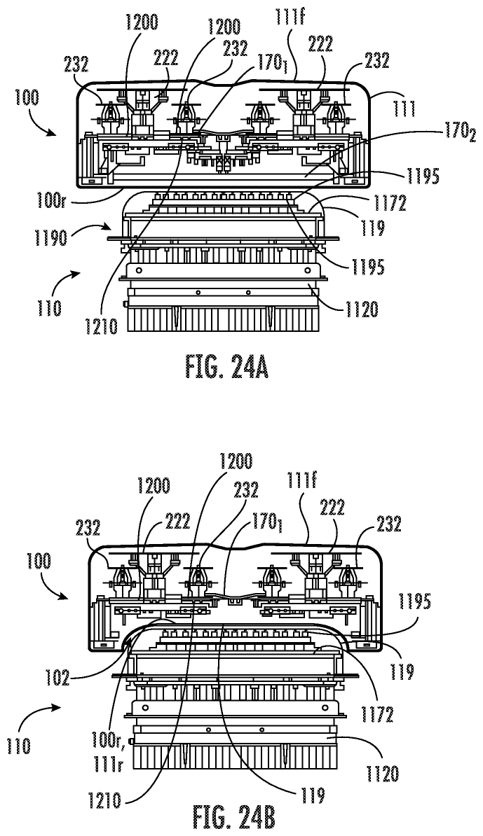

The base station antenna 100 can couple to or include at least one active antenna module 110. The term “active antenna module” is used interchangeably with “active antenna unit” and “AAU” and “active antenna” and refers to a cellular communications unit comprising radio circuitry and associated radiating elements. The radio circuitry is capable of electronically adjusting the amplitude and/or phase of the subcomponents of an RF signal that are output to different radiating elements of an array or groups thereof. The active antenna module 110 comprises the radio circuitry and the radiating elements (e.g., a multi-input-multi-output (mMIMO) beamforming antenna array) and may include other components such as filters, a calibration network, an antenna interface signal group (AISG) controller and the like. The active antenna module 110 can be provided as a single integrated unit or provided as a plurality of stackable units, including, for example, first and second sub-units such as a radio sub-unit (box) with the radio circuitry and an antenna sub-unit (box) with a multi-column array of radiating elements and the first and second sub-units stackably attach together in a front to back direction of the base station antenna 100, with the radiating elements 1195 of an antenna assembly 1190 of the AAU 110 closer to the front radome 111f of the housing 100h/radome 111 of the base station antenna 100 than the radio circuitry unit 1120 (FIGS. 24A, 24B). In some embodiments, the radiating elements 1195 may comprise a separate sub-unit from the radio circuitry and the radiating element sub-unit may be mounted within the base station antenna 100 instead of being external to the base station antenna 100.

The base station antenna 100 has a housing 100h. The housing 100h may be substantially rectangular with a flat rectangular cross-section. The housing 100h may be provided to define at least part of a radome 111 with at least the front side 111f configured as a dielectric cover that allows RF energy to pass through in certain frequency bands. The housing 100h may also be configured to that the rear 100r defines a rear side 111r radome opposite the front side radome 111f. Optionally, the housing 100h and/or the radome 111 can also comprise two (narrow) sidewalls 100s, 111s facing each other and extending rearwardly between the front side 111f and the rear side 111r. Typically, the top side 100t of the housing 100h may be sealed in a waterproof manner and may comprise an end cap 120 and the bottom 100b of the housing 100h may be sealed with a separate end cap 130. The front side 111f, the sidewalls 111s and typically at least part of the rear side 111r of the radome 111 are substantially transparent to radio frequency (RF) energy within the operating frequency bands of the base station antenna 100 and active antenna module 110. The radome 111 may be formed of, for example, fiberglass or plastic.

Still referring to FIG. 3A, in some embodiments, an active antenna module 110 can attach to the base station antenna 100 using a frame 112 and accessory mounting brackets 113, 114. The rear 111r of the housing 100h may be a flat surface extending along a common plane over an entire longitudinal extent thereof or along at least a portion of the longitudinal extent thereof.

As will be discussed further below, the base station antenna 100 includes an antenna assembly 190, which can be referred to as a “passive antenna assembly”. The term “passive antenna assembly” refers to an antenna assembly having arrays of radiating elements that are coupled to radios that are external to the antenna, typically remote radio heads that are mounted in close proximity to the base station antenna 100. The arrays of radiating elements included in the passive antenna assembly 190 (FIG. 23) are configured to form static antenna beams (e.g., antenna beams that are each configured to cover a sector of a base station). The passive antenna assembly 190 can comprise a reflector 170, 214 with radiating elements projecting in front of the reflector and the radiating elements can include one or more linear arrays of low band radiating elements that operate in all or part of the 617-960 MHz frequency band and/or one or more linear arrays of mid-band radiating elements that operate in all or part of the 1427-2690 MHz frequency band. The passive antenna assembly 190 is mounted in the housing 100h of base station antenna 100 and one or more active antenna modules 110 can releasably (detachably) couple (e.g., directly or indirectly attach) to the housing 100h of base station antenna 100.

FIG. 3B illustrates that the rear surface 100r of the housing 100h can comprise a recessed and/or stepped segment 102 facing the active antenna module 110. FIG. 3A illustrates that no recessed and/or stepped segment 102 is required. Where used, the stepped segment 102 can define a sub-segment of the rear 100r of the housing 100h. The stepped segment 102 can have a lateral and longitudinal extent that is the same or greater than a lateral and longitudinal extent of the active antenna module 110. The rear surface 100r can also comprise a pair of spaced apart longitudinally extending rails 118 that engage an adapter mounting bracket 1118 on the active antenna module 110 to attach the active antenna module 110 to the base station antenna housing 100h.

Referring again to FIG. 3A, in another embodiment, the rear surface 100r can comprise a plurality of longitudinally spaced apart mounting structure brackets, shown as upper, medial, and lower brackets, 115, 116, 117, respectively, that extend rearwardly from the housing 100h. In some embodiments, the mounting structure brackets 115, 116, 117 may be configured to couple to one or more mounting structures such as, for example, a tower, pole or building (not shown). At least two of the mounting structure brackets 115, 116 can also be configured to attach to the frame 112 of the base station antenna arrangement, where used. The frame 112 may extend over a sub-length of a longitudinal extent L of base station antenna 100, where the sub-length is shown in FIG. 3A as being at least a major portion thereof (at least 50% of a length thereof). The frame 112 can comprise a top 112t, a bottom 112b and two opposing long sides 112s that extend between the top 112t and the bottom 112b. The frame 112 can have an open center space 112c extending laterally between the sides 112s and longitudinally between the top 112t and bottom 112b.

The frame 112, where used, may be configured so that a variety of different active antenna modules 110 can be mounted to the frame 112 using appropriate accessory mounting brackets 113, 114. As such, a variety of active antenna modules 110 may be interchangeably attached to the same base station antenna 100. While the frame 112 is shown by way of example, other mounting systems may be used.

In some embodiments, a plurality of active antenna modules 110 may be concurrently attached to the same base station antenna 100 at different longitudinal locations using one or more frames 112. Such active antenna modules 110 may have different dimensions, for example, different lengths and/or different widths and/or different thicknesses.

Turning now to FIG. 4, an example primary reflector 214 for a base station antenna 100 is shown. As shown, the primary reflector 214 has a first section 214₁ that extends a first longitudinal distance and that merges into a second section 214₂ with spaced apart right and left side segments 214s having a lateral extent d2 that is less than a lateral extent d1 of the first section 214₁. An open medial region 14 can extend longitudinally and laterally about the second section 214₂. The open medial region 14 can have a lateral extent d3 that is 60-95% of the lateral extent d1, in some embodiments. The first section 214₁ can have a longitudinal extent that is greater than the second section 214₂, typically at least 20% greater, such as 30%-80% greater, in some embodiments.

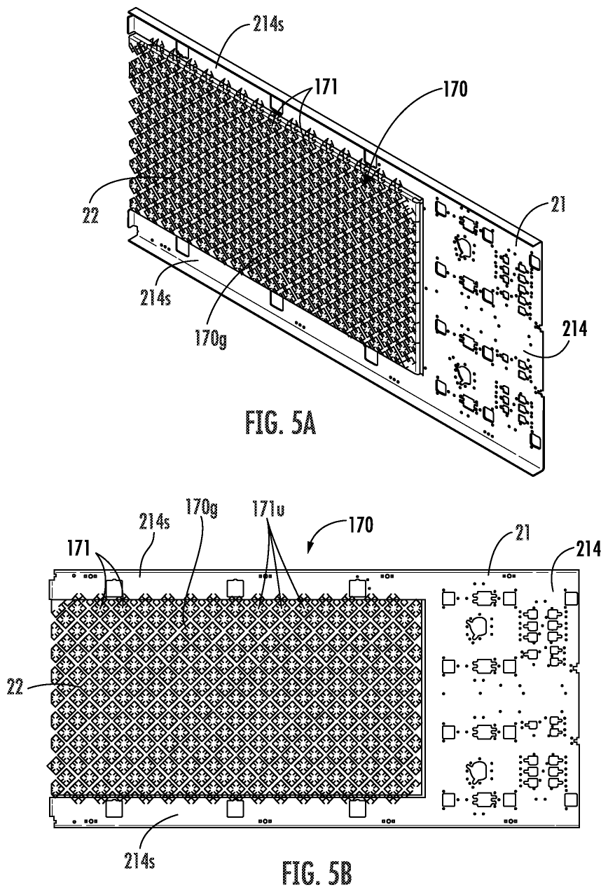

FIGS. 5A and 5B illustrate an example grid reflector 170 for base station antennas 100. The grid reflector 170 comprises a frequency selective surface and may interchangeably be referred to as a “frequency selective reflector”. The grid reflector 170 can extend part of or a full lateral extent of the base station antenna 100 and at least a part of a length of the base station antenna 100.

In some embodiments, the grid reflector 170 can be electrically and/or mechanically coupled to the primary reflector 214. In some embodiments, the grid reflector 170 can be positioned to reside between the right and left sides 214s of the primary reflector in the open medial region 14 (FIG. 4). In some embodiments, the grid reflector 170 can be integral with the primary reflector 214.

The grid reflector 170 can be provided as a non-metallic substrate(s) with conductive metal patches arranged to define an array of unit cells 171 or can be a metal grid that provides an array of unit cells 171. The term “unit cells” is also interchangeably referred to as “pattern units”.

The non-metallic substrate can be provided as a multi-layer printed circuit board which can be configured as a rigid, semi-rigid member or as a flex circuit. The non-metallic substrate can be or comprise a plastic, polymer, co-polymer and/or dielectric with a metallized surface(s) providing conductive patches defining at least part of the array of unit cells 171.

The grid reflector 170 can be provided as a sheet of metal, such as aluminum, with the sheet metal shaped to form the array of unit cells 171. The array of unit cells 171 can be punched, etched or laser formed apertures that are formed through the sheet metal, or can be otherwise formed.

The grid reflector 170 provides a frequency selective surface(s) and/or substrate (referred to interchangeably as a “frequency selective surface” and “frequency selective reflector”) that is configured to allow RF energy (electromagnetic waves) to pass through in one or more first frequency bands and that is configured to reflect RF energy at one or more different second frequency bands. The frequency selective surface and/or substrate may also be interchangeably referred to as a “FSS” herein.

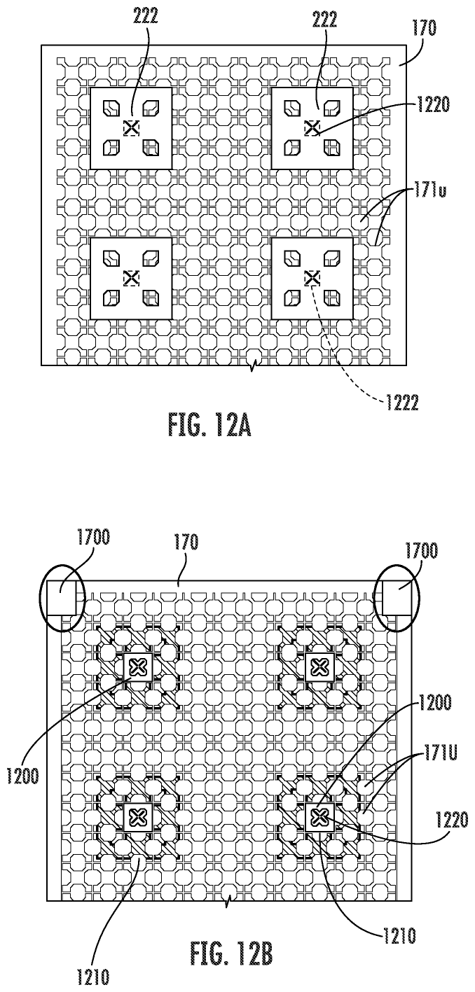

The grid reflector 170 of the base station antenna 100, can reside behind at least some antenna elements 222 (FIGS. 12A, 13A, 14A, 14B, 15, 18-22, 23, 24A, 24B) and can selectively reject some frequency bands and permit other frequency bands to pass therethrough by including the frequency selective surface and/or substrate to operate as a type of “spatial filter”. See, e.g., Ben A. Munk, Frequency Selective Surfaces: Theory and Design, ISBN: 978-0-471-37047-5; DOI: 10.1002/0471723770; April 2000, Copyright © 2000 John Wiley & Sons. Inc. the contents of which are hereby incorporated by reference as if recited in full herein.

The frequency selective surface and/or substrate material of the grid reflector 170 can comprise one or more of a metamaterial, a suitable RF material or even air (although air may require a more complex assembly). The term “metamaterial” refers to composite electromagnetic (EM) materials. Metamaterials may comprise sub-wavelength periodic microstructures.

The FSS material can be provided as one or more cooperating layers. The FSS material can include a substrate that has a dielectric constant in a range of about 2-4, such as about 3.7 and a thickness of about 5 mil and metal patterns forming unit cells 171 formed on the dielectric substrate. The thickness can vary but thinner materials can provide lower loss. As discussed above, alternatively, the FSS material can be provided as sheet metal with an array of unit cells 171.

In some embodiments, the frequency selective substrate/surface of the grid reflector 170 can be configured to act like a High Pass Filter essentially allowing low band energy (e.g., energy in the 600-1000 MHz frequency range) to substantially reflect (the FSS can act like a sheet of metal) while allowing higher band energy, for example, about 3.5 GHz or greater, to substantially pass through. Thus, the frequency selective substrate/surface is substantially transparent or invisible to the higher band energy and a suitable out of band rejection response from the FSS can be achieved. The FSS material may allow a reduction in filters or even eliminate filter requirements for looking back into the radio 1120 (FIGS. 3A, 3B, 24A, 24B).

As discussed above, in some embodiments, the grid reflector 170 with the FSS may be implemented by forming the frequency selective surface on a printed circuit board, optionally a flex circuit board. In some embodiments, the grid reflector 170, for example, may be implemented as a multi-layer printed circuit board, one or more layers of which formed with a frequency selective surface configured such that electromagnetic waves within a predetermined frequency range substantially cannot propagate through the grid reflector 170, and wherein one or more other predetermined frequency range associated with the one or more layers of the multi-layer printed circuit board is allowed to substantially pass therethrough.

Referring to FIGS. 5A and 5B, a grid (frequency selective) reflector 170 according to embodiments of the present disclosure is shown. The grid reflector 170 can be used in the base station antenna 100, such as shown in FIGS. 3A, 3B, for example. The grid reflector/frequency selective reflector 170 may be arranged as an integrated or separate component of a primary reflector 214. The primary reflector 214 can be metallic (e.g., formed of a substantially solid or continuous layer of aluminum sheet metal).

The grid reflector 170 with the frequency selective surface may be provided at a position corresponding to the installation position of the active antenna module 110 of the base station antenna 100 and may be configured to allow electromagnetic waves within a predetermined frequency range (for example, high-frequency electromagnetic waves within the range of 2300 to 4200 MHz or a portion thereof) to pass. In this way, when the base station antenna 100 is assembled, the high-frequency electromagnetic waves emitted by the active antenna module 110 can pass through the frequency selective reflector 170.

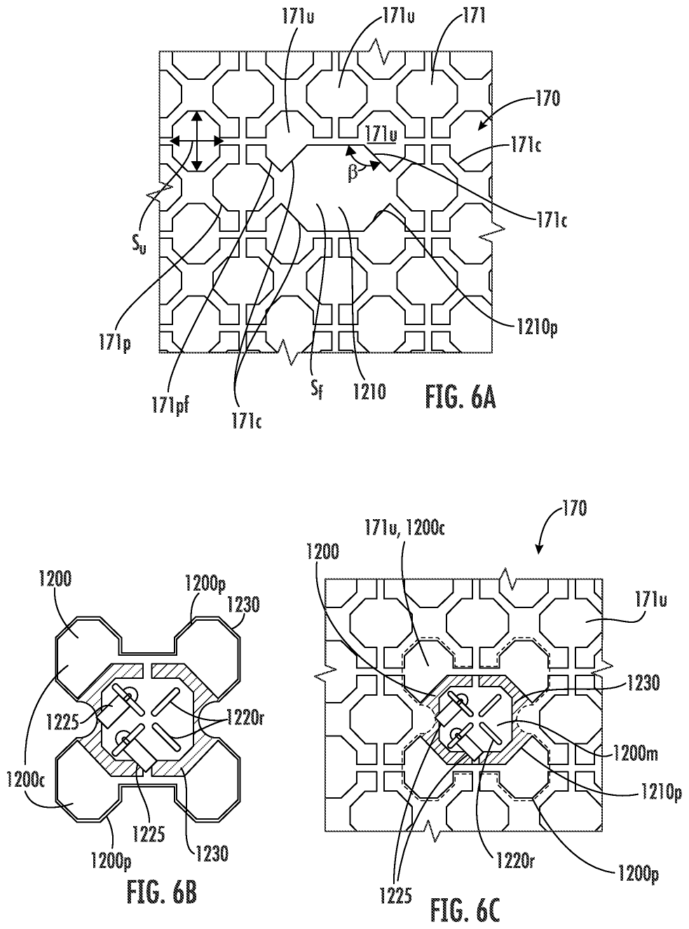

Referring to FIGS. 6A-6C, the grid reflector 170 comprises a feed board aperture 1210 and a corresponding feed board 1200 that covers some or all of a corresponding feed board aperture 1210. FIG. 6A shows the grid reflector 170 with an example feed board aperture 1210 and perimeter 1210p of the feed board aperture 1210. FIG. 6B shows an example feed board 1200 with feed stalk 1220 and FIG. 6C illustrates an assembled view of the grid reflector 170 shown in FIG. 6A and the feed board 1200 shown in FIG. 6B.

Referring to FIG. 6C, the grid reflector 170 can comprise the array of unit cells or pattern units 171u. A plurality of pattern units 171u can surround the feed board aperture 1210. The perimeter 1210p of the feed board aperture 1210 can extend through one or more of the pattern 171 of units 171u so that the pattern units 171u about the perimeter 1210p are incomplete patterns relative to other pattern units 171u and hence have a different shape than other unit cells 171u. The feed board perimeter 1210p can define a plurality of corner segments 171c of a set of unit cells surrounding the feed board perimeter 1210p. The corner segments 171c can be curvilinear and may have a portion that extends at an angle β (see FIG. 6A) that is different and/or that has a different length than corner segments 171c of unit cells 171 that are spaced apart from the feed board aperture 1210. In some embodiments, the angle β can be between 30-60 degrees from horizontal. The unit cells 171u surrounding a respective feed board aperture 1210, shown as four unit cells 171u in FIG. 6A, can have perimeter 171pf that has a different shape than perimeters 171p of other unit cells 171u.

The feed board 1200 can have a perimeter 1200p and/or shaped portion 1200m (FIGS. 6B, 8) configured to cooperate with the grid reflector 170 so as to replicate at least part of the unit cell 171u structure of the grid 170. The feed board 1200 can have at least a portion that has a shape that corresponds to a shape of a unit cell 171u (or to part of a shape of a unit cell 171u). FIG. 6B illustrates that the perimeter 1200p is curvilinear and comprises four corner segments 1200c that have a shape of corresponding unit cells 171u. FIG. 6C illustrates that the corner segments 1200c can reside over or under corresponding unit cells 171u when assembled. The feed board 1200 can reside in front of the grid reflector 170 or behind the grid reflector 170. The corner segments 1200c can be coupled to front or rearward facing surfaces of corresponding ones of the unit cells 171u of the grid reflector 170. The corner segments 1200c on a front or rear facing primary surface can comprise a conductive metal such as copper and define part of a ground layer 1230. As shown, the ground layer 1230 is not continuous across the front or rear of the entire feed board 1200 so that the pattern of the unit cells 171u is replicated on the feed board 1200

The ground layer 1230 of the feed board 1200 cooperates with the grid reflector 170 to form part of the unit cell structure and/or function of the FSS of the grid reflector 170.

The feed board aperture 1210 can have a surface area Sf that is greater than the surface area Su of a unit cell 171u, typically greater than at least two of the unit cells 171u and less than 10 (ten) of the unit cells 171u, where the unit cells 171u can have the same surface area, or have an average of the max and min, where they are different. It will be appreciated, however, that since the feed board 1200 replicates the pattern of the unit cells 171u and hence acts as an FSS surface, the feed board apertures 1210 can have any size and may replace a larger number of unit cells 171u of the grid reflector 170 in some embodiments.

The feed stalks 1220 for each radiating element 222 may comprise printed circuit board-based feed stalks in some embodiments, although die cast or sheet metal feed stalks may alternatively be used. When implemented using printed circuit boards, a feed stalk 1220 may comprise a pair of printed circuit boards that have cooperating slots that allow the two printed circuit boards to be joined together where the printed circuit boards are rotated 90 degrees with respect to each other, as is well known in the art. In such embodiments, each printed circuit board typically includes two rearwardly-extending tabs 1220l, which facilitates fixedly mounting the radiating element 222 to the feed board 1200 via soldering. The feed stalk 1220 can have a plurality of rearwardly-extending tabs 1220l, shown as four tabs in the depicted embodiments, that extend rearwardly through the feed board 1200. Two coaxial feed cables 1225 (one for each polarization) can be provided and can reside behind the grid reflector 170. Each coaxial cable 1225 can be connected to one of the rearwardly-extending tabs 1220l of a respective one of the printed circuit boards of the 1220 in order to pass RF signals between the radiating element 222 and a feed network for the passive antenna assembly 190.

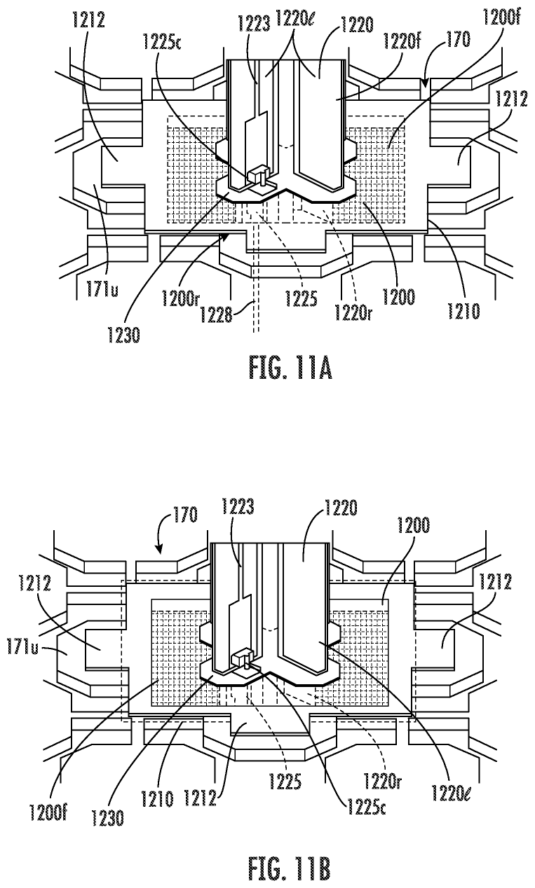

Since the coaxial cables 1225 couple directly to the feed stalks 1220 behind the feed board 1200, no signal transmission traces are required on a front surface of the feed board 1200, e.g., the front surface 1200f of the feed board 1200 can be devoid of metal. One primary surface of the feed board 1200 can comprise a conductive electrical ground layer 1230 which can be a copper layer. The ground layer 1230 can be on a rear primary surface 1200r (FIG. 11A) or a front primary surface 1200f (FIG. 11B). The ground layer 1230 can be configured to occupy only a sub-portion of a surface area of the primary front or rear surface of the feed board 1200 can be provided by patterned segments thereon.

In some embodiments, each coaxial cable 1225 can extend orthogonal to the feed stalk 1220 (FIGS. 8, 9, 10, 13A, 15) to which it is connected. In other embodiments, each coaxial cable 1225 can be in-line (parallel to) its associated feed stalk 1220 (FIGS. 11A, 11B). The in-line configuration removes any bend in the coaxial cables 1225 relative to the feed board 1200 and may provide ease in assembly or installation or lower cost assemblies.

Referring to FIGS. 11A and 11B, for example, a center conductor 1225c of the coaxial cables 1225 can connect to a signal trace 1223 on a forward portion 1220f of at least one tab 1220l of the feed stalk 1220 and the ground conductor of the coaxial cable can connect to a ground plane on the feed board 1200.

FIG. 7 illustrates the feed board aperture 1210 can be polygonal, such as square or rectangular and can couple to a single feed board 1200 with a feed stalk 1220 of a single radiating element 222. The feed board 1200 or at least a portion hat is a shaped segment 1200m in the form of all or part of a unit cell 171u does not require, and is typically devoid of, signal transmission traces. The feed board 1200 can have a perimeter 1200p (shown in broken line in front of the rear surface of the grid reflector 170) with at least a portion that extends beyond the feed board aperture 1210 to physically couple to the grid reflector 170 thereat.

FIG. 8 illustrates another configuration of a feed board aperture 1210 and feed board 1200. The ground layer 1230 of the feed board 1200 can have a unit cell shaped segment 1230u that is shaped to mimic or be the same as a unit cell 171u of the grid reflector 170. The ground layer 1230 may also include ground strips 1231 that align with metal strips 171s of the array of unit cells 171 (and plates) that can capacitively couple with metal of the grid reflector 170, such as to one or more unit cells 171u, to provide a capacitive connection between the grid reflector 170 and the feed board 1200.

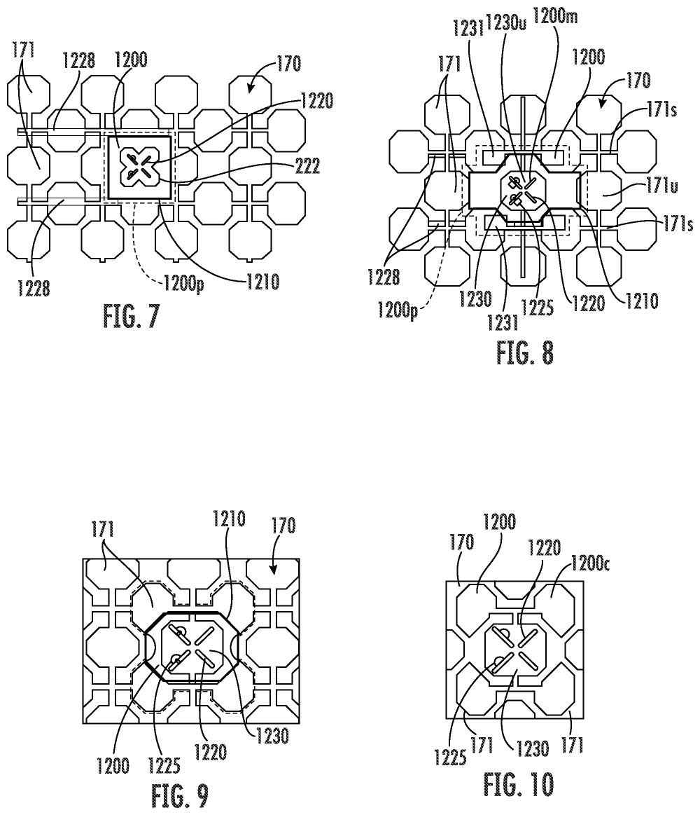

FIGS. 9 and 10 illustrate a feed board aperture 1210 and feed board 1200 similar to that shown in FIGS. 6A-6C. The feed board 1200 includes a ground layer 1230 which has shaped corner segments 1200c with a primary surface thereof defining part of a ground layer 1230 and a shaped segment 1230m that is coupled to the feed stalk 1220. The ground layer 1230 is discontinuous across an entire primary surface of the feed board 1200 in contrast to conventional feed boards.

FIGS. 8-10, for example, show embodiments whereby at least a portion of the structure of the unit cell 171u of the grid reflector 170 is replicated and/or formed on the feed board 1200 to provide a continuous unit cell structure using the combination of the grid array 171 and the feed board 1200. The metal pattern on the feed board 1200 can be capacitively coupled to the grid reflector 170 by having overlapping portions with the same shape and/or pattern. The result is that the feed boards 1200 and grid reflector 170 together act like a grid reflector 170 providing the FSS. This allows mid-band and/or low-band radiating elements to be positioned in front of and over or on the grid reflector 170 and to feed those radiating elements without any substantial compromise in the performance of the grid reflector 170. The metal pattern on the feed board 1200 can have the same shape as the metal on grid reflector 170 and the metal on feed board 1200 can couple to the metal of the reflector 170.

In other embodiments, the reflector 170 is not required to electrically couple with metal on the feed board 1200.

The metal on the feed board 1200 can combine with the reflector cutout/aperture 1210 to contribute the same pattern or pattern feature of all or a portion of one or more unit cells 171u of the grid reflector 170.

FIG. 11A illustrates that the ground layer 1230 can be provided on a rear surface 1200r of the feed board 1200 and no signal transmission traces for the radiating element(s) are required on the front surface 1200f. As shown, the center conductor 1225c of the coaxial feed cable 1225 can be directly soldered to the feed stalk 1220. The ground conductor 1225c of the coaxial feed cable 1225 can be directly soldered to the ground layer 1230 on the rear surface 1200r of the feed board 1200.

FIG. 11B illustrates that the ground layer 1230 can be provided on a front surface 1200f of the feed board 1200 and no signal traces for the radiating element(s) are required on the front surface 1200f. As shown, the coaxial feed cable 1225 can extend through a hole in the feed board 1200 to the front side thereof. The center conductor 1225c of the coaxial feed cable 1225 can be directly soldered to the feed stalks 1220, and the ground conductor of the coaxial feed cable 1225 can be directly soldered to the ground layer 1230 on the front surface 1200r of the feed board 1200.

FIGS. 11A and 11B also illustrate fastening segments 1212 on outer perimeter portions of the feed board 1200 configured to couple to unit cells 171u of the grid reflector 170. The fastening segments 1212 can be provided in any suitable number, typically in a range of 2-4. The fastening segments 1212 provide a structure for fastening the feed board 1200 to the grid reflector 170 (e.g., by soldering, by fasteners, by adhesive tape, etc.), and may also form capacitive connections between the ground layer or plane 1230 on the feed board 1200 and the grid reflector 170 so that both structures are at a common ground potential. In FIG. 11A, the center conductor is at the bottom side of the feed board 1200 (printed circuit board). One difference between FIGS. 11A and 11B is the solder joint between the center conductor and dipole stalk. The solder joint in FIG. 11A is at bottom, and the solder joint in FIG. 11B is at the top side.

While the above discussion assumed a capacitive connection between the feed board 1200 and the grid reflector 170, embodiments of the present invention are not limited thereto. In other embodiments, the feed board 1200 can be galvanically electrically coupled to the grid reflector 170 (e.g., by soldering).

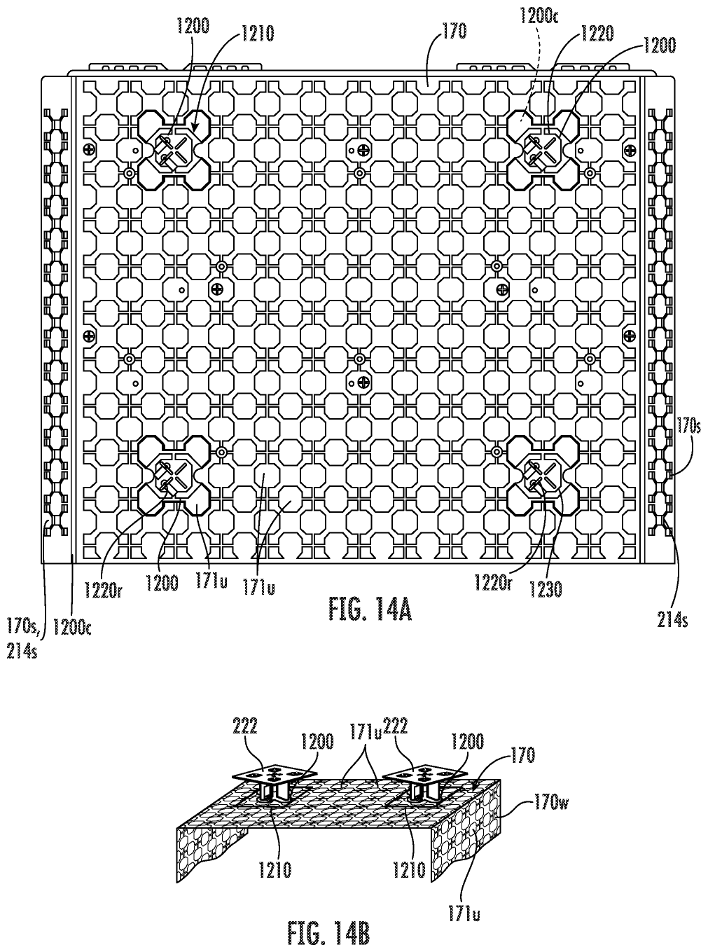

FIGS. 12A, 12B, 14A and 14B illustrate that the grid reflector 170 can include a plurality of spaced apart feed boards 1200 with respective feed board apertures 1210 in the grid reflector 170. Respective radiating elements 222 may be mounted by their feed stalks 1220 to extend forwardly from the feed boards 1200. FIG. 12B also illustrates corner bracket attachment portions 1700 can be provided on a rear surface.

Referring to FIGS. 11A, 13A, 16 and 17, a forward portion 1220f of a feed stalk 1220 of a respective radiating element 222 can project forward of the feed board 1200 and grid reflector 170. A rearward portion 1220r of the feed stalk 1200 can also project rearward of the feed board 1200 and grid reflector 170 and thus through the feed board aperture 1210.

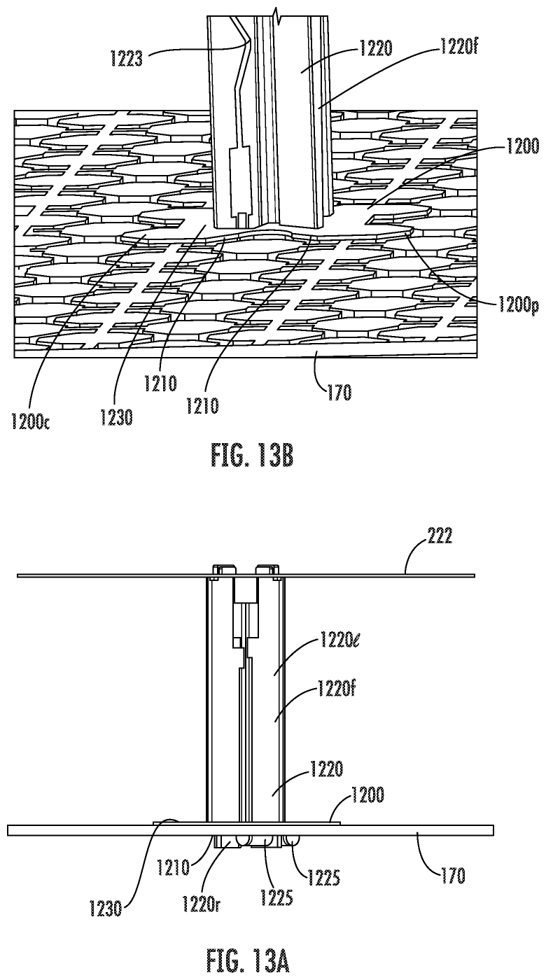

FIGS. 13A and 13B illustrate that the rearward portion 1220r of the feed stalk 1220 can have a lesser length that the forward portion 1220f (measured in a front to back direction of the base station antenna housing 100h).

Referring again to FIG. 14A, the feed board apertures 1210 and feed boards 1200 can reside at laterally inward positions on the grid reflector 170 that are spaced apart from outer strip portions 170s or 214s of the grid reflector 170.

FIG. 14B illustrates that the grid reflector 170 can optionally be configured as a three-dimensional grid reflector with side walls 170w projecting rearward comprising unit cells 171u.

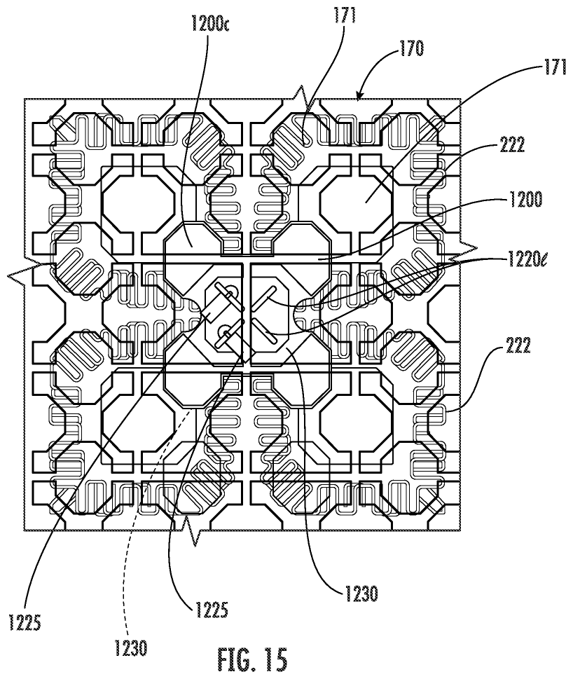

FIG. 15 is an enlarged view of the grid reflector 170, feed board 1200 and radiating element 222, viewed from the back, similar to FIG. 6C, and also showing radiating element 222 according to some embodiments of the present invention. The four dipole arms of the radiating element are visible in FIG. 15. The radiating element 222 may have the design shown in U.S. Provisional Application Ser. No. 63/241,676, filed Sep. 8, 2021, the entire content of which is incorporated herein by reference.

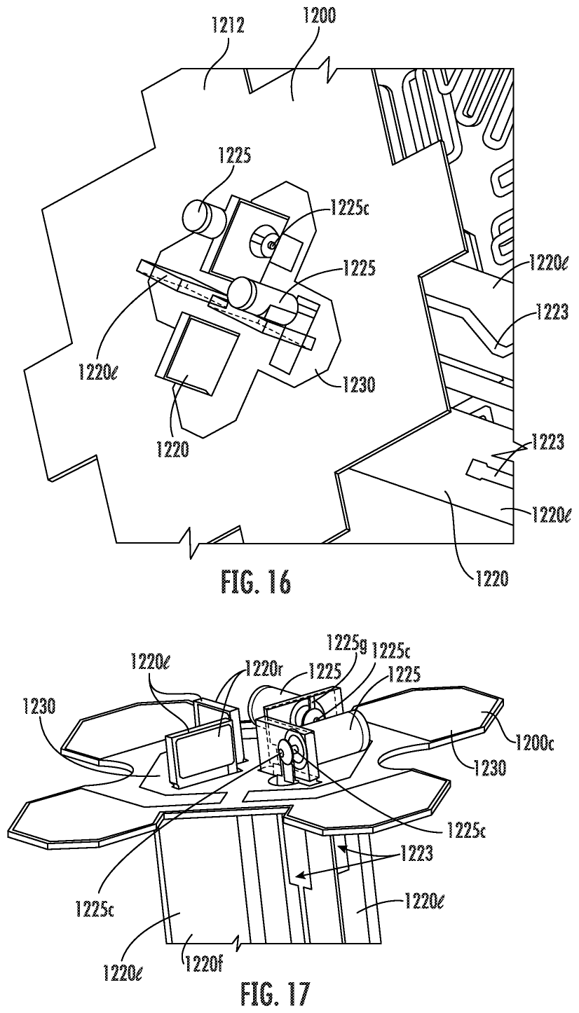

FIGS. 16 and 17 are enlarged rear perspective views of example feed boards 1200, coaxial cables 1225, ground layers 1230 and feed stalks 1220. FIG. 16 shows the coaxial cables 1225 in-line with, parallel to, the feed stalk 1220, orthogonal to primary surfaces of the feed board 1200. FIG. 17 shows the coaxial cables 1225 orthogonal to the feed stalk 1220, parallel to the primary surfaces of the feed board 1200.

FIG. 17 shows the center conductor 1225c extending through the rearward tab 1220l to connect to a feed trace 1223 on the stalk 1220 while the ground conductor 1225g of the cable 1225 connects to a ground layer and/or plane 1230 on the opposed side of the tab 1220l. Referring to FIG. 16, the center conductor 1225c of the PCB can be the grounded plane of the dipole 222. There can be three functions of this grounded plane. First, the grounded plane has a short circuit at the bottom of dipole stalk to make it a part of the dipole balun. Second, the grounded plane couples to the cutout 1210 of the reflector 170 to make the dipole grounded to the reflector. Third, the grounded plane combines with the cutout 1210 on the reflector 170 to create a FSS pattern unit feature. With respect to the second function, the grounded plane and the reflector provides the coupling connection. By coupling to the (perimeter of) cutout, the overall cutout with the center conductor contributes to the pattern unit feature/FSS feature, and this FSS feature at the horizontal for the current is the lowpass filter so the low band current couples from the center conductor to the cutout 1210.

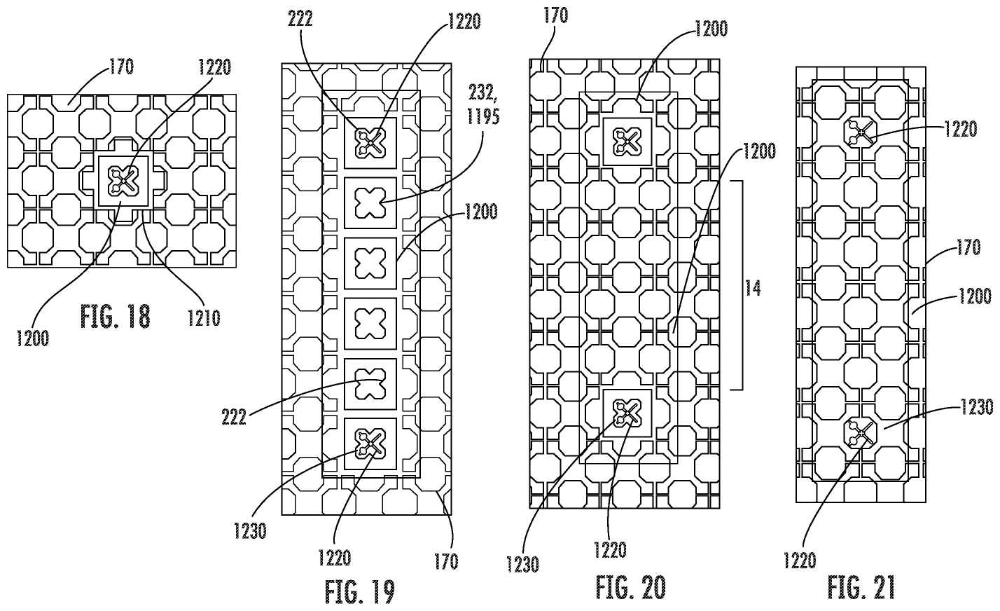

FIGS. 18-21 illustrate that one or more than one radiating element 222 may be mounted on the feed board 1200. FIG. 18 shows a 1×1 configuration (one feed stalk 1220 for one feed board 1200). FIGS. 19-21 show a 2×1 elongate configuration with the ground layer 1230 and/or dipole base of the radiating elements 222 arranged in different alignments with respect to the array of unit cells 171 of example grid reflectors 170.

FIGS. 18-21 show examples of how different configurations can be extended for implementation. FIG. 19 is based on FIG. 7 to extend the low band from 1-to-1 to a 1-to-2 feed board 1200. The low band element 222 is located at each side of the feed board 1200. High band radiating elements 1195 can reside between the low band radiating elements 222. This figure shows that not only low band radiating elements 222 can use this idea, but also high band. Also, low band radiating elements 222 and high band radiating elements 1195 can be arranged together in a feed board 1200.

FIG. 20 shows the low band radiating elements 222 at each end side, and the middle area can have a larger open space/cutout 14. With this design, the feed board 1200 has a large cutout at the middle area to keep a middle region with an open space similar to the original cutout 14 shown in FIG. 4 on the reflector 170.

FIG. 21 is based on FIGS. 8/9/10. By adjusting the center conductor to match the reflector cutout 1210, the configuration is extendable from the 1-to-1 feed board 1200 to a 1-to-2 feed board 1200 or even more, from a 1-to-N feed board 1200 for corresponding radiating elements, where N>2 radiating elements.

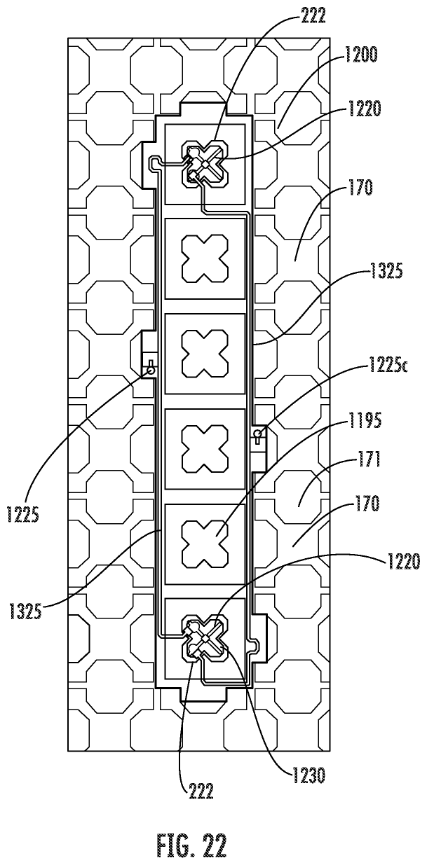

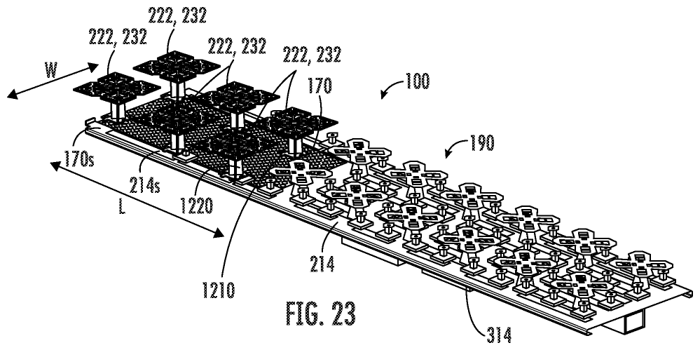

FIG. 22 shows an elongate feed board 1200 with a plurality of feed stalks 1220, spaced apart, and connected to common center conductor feeds 1225c via conductive traces 1325 so that a power splitter is able to split signal in two directions for two different radiating elements 222. The middle radiating elements (clover shaped patch elements) can be the same as the radiating element 222 shown at each end side, but no cutout/slot 1210 is required because no dipole is located on them. If this feed board 1200 is used for a multi band antenna, the middle four radiating elements can be used for the other band dipoles. For example, mid-band 232 and/or high band radiating elements 1195 can be positioned in between the low band elements 222 as a low band and high band array interleave design.

FIG. 23 shows the passive antenna assembly 190 with the grid reflector 170 and with a primary reflector 214. The passive antenna assembly 190 also includes low band radiating elements 222 and mid-band radiating elements 232 projecting forward of the grid reflector, inward from the reflector strips 214s or reflector outer sides 170s.

The radiating elements in front of the grid reflector 170 can comprise low band 222 and/or mid band 232 radiating elements (FIGS. 24A, 24B).

The feed board 1200 can cooperate with the grid reflector 170 to reflect energy of the low band and/or mid band radiating elements while being transparent or “invisible” to high band radiating elements, such as mMIMO elements 1195 (FIGS. 24A, 24B) positioned behind the grid reflector 170.

Referring to FIG. 24A, a second grid reflector 170₂ can be positioned between the first grid reflector 170₁ with the feed board 1200 and feed board aperture 1210 and an active antenna unit 110.

The pattern units or unit cells 171u can be periodically arranged in the transverse and longitudinal directions of the base station antenna 100. Each of the pattern units/unit cells 171u may have a predetermined pattern and may include a capacitor structure and an inductor structure connected in series and/or parallel with the capacitor structure. In addition, each of the pattern units 171u may be electrically connected to each other through the inductor structure. For example, the inductor structure in each pattern unit/unit cell 171u may be electrically connected to the inductor structure of an adjacent pattern unit.

The resonance frequency of the frequency selective surface of the grid reflector 170 may be configured by selecting or designing the pattern and size of the capacitor structure and the inductor structure of each pattern unit/unit cell 171u, as well as the spacing and arrangement of a plurality of pattern units 171u such that the electromagnetic waves within a predetermined frequency range can pass through the frequency selective section.

In addition, the unit cells/pattern units 171u may have various shapes, such as triangle, rectangle, rhombus, pentagon, hexagon, circle, oval, part oval, and the like and combinations of different shapes for different unit cells. Further description of example grid reflectors can be found in co-pending PCT/CN2022/080578, the contents of which are hereby incorporated by reference as if recited in full herein.

In some embodiments according to the present disclosure, the frequency selective section may be configured as a slotted frequency selective section, which may be achieved by periodically opening slots of metal units on a metal plate and forming various pattern units periodically arranged, for example. To this end, in an embodiment according to the present disclosure, a slot may be formed by punching or laser direct structuring (LDS) at a corresponding position of the metallic main body or primary reflector portion 214 to form a frequency selective section. The primary reflector 214 and the frequency selective section 170 may be integrally formed of a metal plate or sheet, thereby ensuring that the formed frequency selective reflector 170 has sufficient strength. In other embodiments, the primary reflector 214 and the frequency selective substrate 170 may be formed as separate components and then coupled or fixed together in an appropriate manner to form the grid (frequency selective) reflector 170. In some embodiments, the primary reflector 214 and the frequency selective section 170 may also be made of different materials.

In some embodiments according to the present disclosure, the grid reflector 170 can comprise a patch type frequency selective section, which may be achieved by forming periodically arranged metal pattern units on a substrate. The plurality of metal pattern units may be formed on the substrate by a selective electroplating process or a metal ink transfer printing process. In some embodiments, the substrate may be formed of plastic, and the metal pattern unit may be formed of metal materials such as copper, aluminum, gold, and silver. In order to increase the strength of the frequency selective reflector 170, the substrate may be formed of high-strength plastic.

The grid reflector 170 can be configured with the unit cells 171u having an open interior 172 devoid of metal and each unit cell 171u can include a metal perimeter. The grid reflector 170 can be provided as a single layer of sheet metal providing the unit cells 171u with the open interiors 172 devoid of metal. In other embodiments the unit cells 171u can have a metal body surrounded at least partially by open spaces and connecting metal strips and/or linear segments.

The grid reflector 170 is configured to allow RF energy (electromagnetic waves) to pass through at one or more first defined frequency range and is also configured to reflect RF energy at a different second frequency range/band.

In some embodiments, the grid reflector 170 of the passive antenna assembly 190 can be configured to act like a High Pass Filter essentially allowing low band energy to completely reflect as the grid is formed by a sheet of metal while allowing higher band energy, for example, about 3.5 GHz or greater, to pass through, typically substantially completely pass through. Thus, the grid reflector 170 is transparent or invisible to the higher band energy and a suitable out of band rejection response can be achieved.

The grid reflector 170 can reside a distance in a range of ⅛ wavelength to ¼ wavelength of an operating wavelength behind the low band (dipole) radiating elements 222, in some embodiments. The term “operating wavelength” refers to the wavelength corresponding to the center frequency of the operating frequency band of the radiating element, e.g., a low band radiating element 222. The grid reflector 170 can reside a distance in a range of 1/10 wavelength to ½ wavelength of an operating wavelength in front of the high band radiating elements 1195 (FIGS. 24A, 24B), in some embodiments. By way of example, in some particular embodiments, the grid reflector 170 can reside a physical distance of 0.25 inches and 2 inches from a ground plane or reflector 1172 that is behind a mMIMO array of radiating elements 1195 of an active antenna module 110 (FIGS. 24A, 24B). Other placement positions may be used.

In some embodiments, the ground plane or reflector 1172 of the active antenna module 110 can be electrically coupled to the grid reflector 170 and/or primary reflector 214 of the base station antenna 100, such as galvanically and/or capacitively coupled. In other embodiments, the ground plane or reflector 1172 of the active antenna module 110 is not electrically coupled to the grid reflector 170 and/or primary reflector 214.

The passive antenna assembly 190 comprises multiple arrays of radiating elements, typically provided in four to eight columns, with radiating elements that extend forwardly from the front side of the primary reflector 214, with some columns of radiating elements continuing to extend in front of the grid reflector 170. The arrays of radiating elements of the antenna assembly 190 may comprise radiating elements 222 that are configured to operate in a first frequency band and radiating elements 232 that are configured to operate in a second frequency band. Other arrays of radiating elements may comprise radiating elements that are configured to operate in either the second frequency band or in a third frequency band. The first, second and third frequency bands may be different frequency bands (although potentially overlapping). In some embodiments, low band antenna elements 222 with dipole arms can reside in front of the grid reflector 170.

Referring to FIG. 23, the passive antenna assembly 190 of the base station antenna 100 can include one or more arrays of low-band radiating elements 222, one or more arrays of mid-band radiating elements 232. The radiating elements 222, 232, 1195 may each be dual-polarized radiating elements. Further details of radiating elements can be found in co-pending WO2019/236203 and WO2020/072880, the contents of which are hereby incorporated by reference as if recited in full herein. Some of the high band radiating elements, such as radiating elements 1195, can be provided as a mMIMO antenna array and may be provided in the active antenna module 110 rather than in the housing 100h of the base station antenna 100.

The low-band radiating elements 222 can be mounted to extend forwardly from the main or primary reflector 214 and the grid reflector 170 and can be mounted in two columns to form two linear arrays 220 of low-band radiating elements 222. Each low-band linear array 220 may extend along substantially the full length of the antenna 100 in some embodiments.

The low-band radiating elements 222 may be configured to transmit and receive signals in a first frequency band. In some embodiments, the first frequency band may comprise the 617-960 MHz frequency range or a portion thereof (e.g., the 617-896 MHz frequency band, the 696-960 MHz frequency band, etc.). The low-band linear arrays may or may not be used to transmit and receive signals in the same portion of the first frequency band. For example, in one embodiment, the low-band radiating elements 222 in a first linear array may be used to transmit and receive signals in the 700 MHz frequency band and the low-band radiating elements 222 in a second linear array may be used to transmit and receive signals in the 800 MHz frequency band. In other embodiments, the low-band radiating elements 222 in both the first and second linear arrays may be used to transmit and receive signals in the 700 MHz (or 800 MHz) frequency band.

The first mid-band radiating elements 232 may likewise be mounted to extend forwardly from the main reflector 214 and/or grid reflector 170 and may be mounted in columns to form linear arrays of first mid-band radiating elements. The linear arrays of mid-band radiating elements 232 may extend along the respective side edges of the grid reflector 170 and/or the main reflector 214. The first mid-band radiating elements 232 may be configured to transmit and receive signals in a second frequency band. In some embodiments, the second frequency band may comprise the 1427-2690 MHz frequency range or a portion thereof (e.g., the 1710-2200 MHz frequency band, the 2300-2690 MHz frequency band, etc.). In the depicted embodiment, the first mid-band radiating elements 232 are configured to transmit and receive signals in the lower portion of the second frequency band (e.g., some or all of the 1427-2200 MHz frequency band). The linear arrays of first mid-band radiating elements 232 may be configured to transmit and receive signals in the same portion of the second frequency band or in different portions of the second frequency band.

Second mid-band radiating elements can be mounted in columns to form linear arrays of second mid-band radiating elements and may be configured to transmit and receive signals in the second frequency band. By way of example, the mid-band radiating elements can transmit and receive signals in an upper portion of the second frequency band (e.g., some, or all, of the 2300-2700 MHz frequency band). In the depicted embodiment, the second mid-band radiating elements 242 may have a different design than the first mid-band radiating elements 232.

The high-band radiating elements 1195 may be configured to transmit and receive signals in a third frequency band. In some embodiments, the third frequency band may comprise the 3300-4200 MHz frequency range or a portion thereof.

It will also be appreciated that the number of linear arrays of low-band, mid-band and high-band radiating elements may be varied from what is shown in the figures. For example, the number of linear arrays of each type of radiating elements may be varied from what is shown, some types of linear arrays may be omitted and/or other types of arrays may be added, the number of radiating elements per array may be varied from what is shown, and/or the arrays may be arranged differently. As one specific example, two linear arrays of second mid-band radiating elements may be replaced with four linear arrays of ultra-high-band radiating elements that transmit and receive signals in a 5 GHz frequency band.

Each array of low-band radiating elements 222 may be used to form a pair of antenna beams, namely an antenna beam for each of the two polarizations at which the dual-polarized radiating elements are designed to transmit and receive RF signals. Likewise, each array of first mid-band radiating elements 232, and each array of second mid-band radiating elements may be configured to form a pair of antenna beams, namely an antenna beam for each of the two polarizations at which the dual-polarized radiating elements are designed to transmit and receive RF signals. Each linear array may be configured to provide service to a sector of a base station. For example, each linear array may be configured to provide coverage to approximately 120° in the azimuth plane so that the base station antenna 100 may act as a sector antenna for a three-sector base station. Of course, it will be appreciated that the linear arrays may be configured to provide coverage over different azimuth beamwidths. While all of the radiating elements 222, 232, 1195 can be dual-polarized radiating elements in the depicted embodiments, it will be appreciated that in other embodiments some or all of the dual-polarized radiating elements may be replaced with single-polarized radiating elements. It will also be appreciated that while the radiating elements are illustrated as dipole radiating elements in the depicted embodiment, other types of radiating elements such as, for example, patch radiating elements may be used in other embodiments.

As the radiating elements 222, 232 can be slant cross-dipole radiating elements, the first and second polarizations may be a −45° polarization and a +45° polarization.

A phase shifter may be connected to a respective one of the RF ports 140 (FIG. 3A). The phase shifters may be implemented as, for example, wiper arc phase shifters such as the phase shifters disclosed in U.S. Pat. No. 7,907,096 to Timofeev, the disclosure of which is hereby incorporated herein in its entirety. A mechanical linkage may be coupled to a RET actuator (not shown). The RET actuator may apply a force to the mechanical linkage which in turn adjusts a moveable element on the phase shifter in order to electronically adjust the downtilt angles of antenna beams that are generated by the one or more of the low-band or mid-band linear arrays.

It should be noted that a multi-connector RF port (also referred to as a “cluster” connector) can be used as opposed to individual RF ports 140. Suitable cluster connectors are disclosed in U.S. patent application Ser. No. 16/375,530, filed Apr. 4, 2019, the entire content of which is incorporated herein by reference.

The radiating elements 222 can be cross-dipole elements configured to operate in some or all the 617-960 MHz frequency band. The signal trace 1223 on the feed stalk 1220 (FIGS. 11A, 11B, 13B) can be a feed circuit comprising a hook balun. Further discussions of example antenna elements including antenna elements comprising feed stalks can be found in U.S. Provisional Patent Application Ser. Nos. 63/087,451 and 62/993,925 and/or related utility patent applications claiming priority thereto, the contents of which are hereby incorporated by reference as if recited in full herein.

FIGS. 24A and 24B illustrate example embodiments of the base station antennas 100 and the active antenna modules 110. FIG. 24A illustrates that the rear 100r of the base station antenna 100 can have a flat surface and the active antenna assembly 1190 can be configured to face the rear 100r with the radomes 119, 111r therebetween and with the grid reflector 170 in front of the radiating elements 1195. FIG. 24B illustrates that the rear 100r of the base station antenna 100 can have recessed segment 102 and sized to receive the radome 119 of the active antenna unit 110, again with the radiating elements 1195 behind and facing the grid reflector 170.

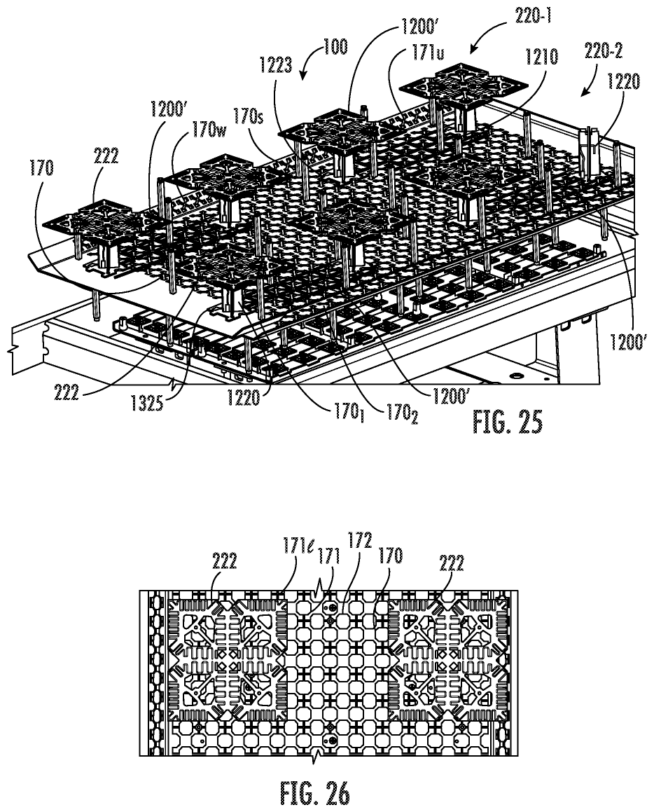

Turning now to FIGS. 25-28, another embodiment of a feed board 1200′ is shown with the grid reflector 170. In this embodiment, the feed board 1200′ has a plurality of spaced apart linear segments 1204 surrounding one or more cutouts or apertures 1205 forming an open lattice type body 1200b. The linear segments 1204 can comprise at least one signal trace 1200t, shown as a plurality of signal traces 1200t, that can define a respective at least one, and preferably a plurality of, conductor signal paths 1325, shown as a first conductor signal path 1325₁ and an electrically isolated second conductor signal path 1325₂, each with a respective power splitter or divider 1326 that diverts the corresponding signal from center conductors 1225c of coaxial cables 1225 to at least respective first and second shaped segments 1200m that align with respective feed stalks 1220. The shaped segments 1200m can have at least part of a curvilinear shape of a corresponding unit cell 171u of the grid reflector 170. The feed boards 1200′ can define more than two conductive signal traces 1200t for more than two signal paths 1325 or a single signal trace for a single conductive signal path 1325. The signal traces 1200t can be provided as microstrip signal traces.

The signal traces 1200t and the grid reflector 170 may together form a series of microstrip transmission lines that are used to carry RF signals between one or more arrays of radiating elements of the base station antenna 100 and other components (e.g., phase shifters) of the base station antenna 100. In particular, the signal traces 1200t may act as the signal traces of the microstrip transmission lines and the grid reflector 170 may act as the ground plane of the microstrip transmission lines. The signal traces 1200t may be separated from the grid reflector by a dielectric layer such as, for example, an air gap, a solder mask or a dielectric substrate of a printed circuit board. In some embodiments, the grid reflector 170 may be formed as a metal layer on a first side of a dielectric substrate (e.g., the dielectric substrate of a printed circuit board) and the signal traces 1200t may be formed as a metal pattern on a second side of the dielectric substrate.

In embodiments where the grid reflector 170 and the feed boards 1200′ are separate elements, each of the feed boards 1200′ can comprise fastening segments 1212 for attaching the feed board 1200′ to the grid reflector 170.

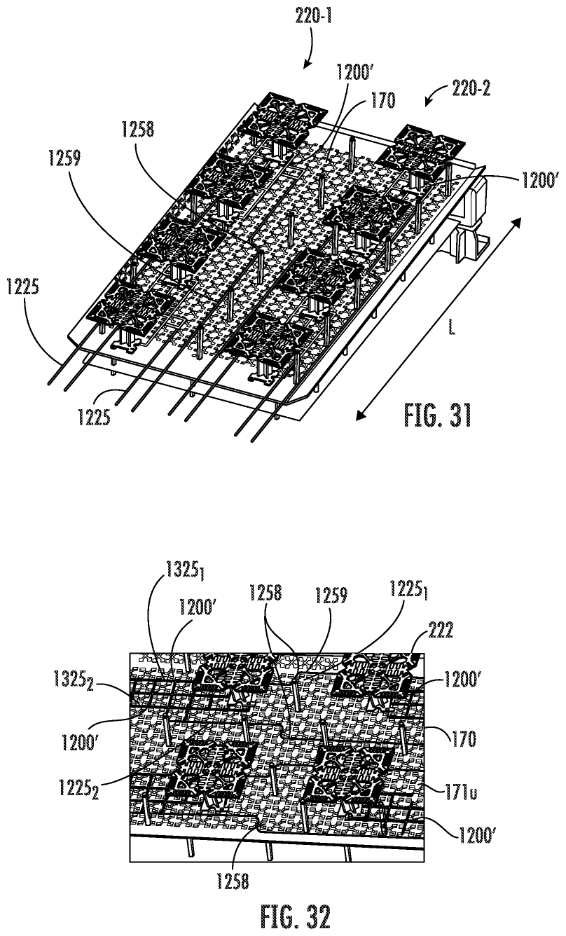

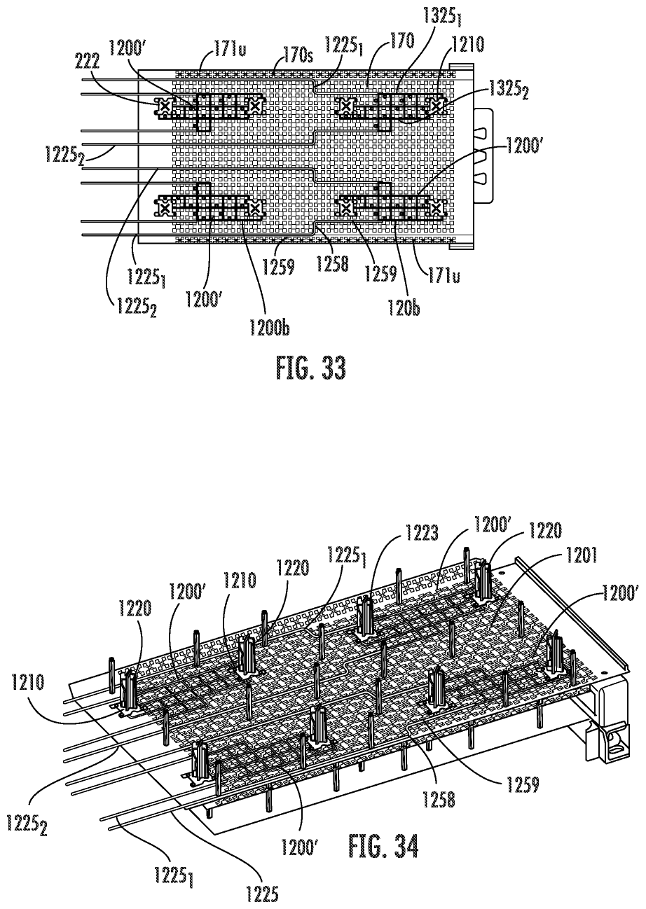

Each of the feed boards 1200′ can have first and second cable connectors 1207 that attach to respective coaxial cables 1225₁, 1225₂ (FIGS. 31-34) and connect to the signal traces 1200t corresponding to respective first and second conductor signal paths 1325₁, 1325₂. In particular, the center conductors of coaxial cables 1225₁, 1225₂ (FIGS. 31-34) connect to the signal traces 1200t corresponding to respective first and second conductor signal paths 1325₁, 1325₂. The ground conductors of coaxial cables 1225₁, 1225₂ (FIGS. 31-34) may be connected to the grid reflector 170.

The signal traces 1200t can be arranged as a series of lateral and longitudinal linear segments 1204 that align with metal linear features of the grid 170. Such an arrangement acts to convert the signal traces 1200t into microstrip transmission lines (since it locates a ground conductor behind each signal trace 1200t) and also locates the signal traces 1200t so that they do not block the openings 172 in the structure of the unit cells 171u, which could reduce the performance of the frequency selective surface. The apertures 1205 of the lattice body 1200b can be sized and configured to provide an open window in front or behind a plurality of unit cells 171u of the grid reflector 170. A first subset of the linear segments 1204 can provide the first conductor signal path 1325₁ and a second subset of the linear segments 1204 can provide the second conductor signal path 1325₂. As noted above, in some embodiments the lattice body 1200b can be selectively metallized on a non-conductive substrate (e.g., a printed circuit board implementation), but it will be appreciated that the lattice body 1200b alternatively could be formed from sheet metal or in other ways. It will also be appreciated that some or all of the linear segments 1204 may be replaced with non-linear segments such as curved segments or meandered segments. This is particularly true in cases where the unit cells 171u of the grid reflector 170 have non-linear segments, as performance may be improved in situations where the lattice body 1200b matches the underlying grid structure.

In some embodiments, the apertures 1205 can be cutouts in the dielectric of the printed circuit board providing the signal traces 1200t and respective conductor signal paths 1325₁, 1325₂. In other embodiments, the apertures 1205 can be non-metallized regions in the dielectric of a printed circuit board that provides the signal traces 1200t and respective conductor signal paths 1325₁, 1325₂.

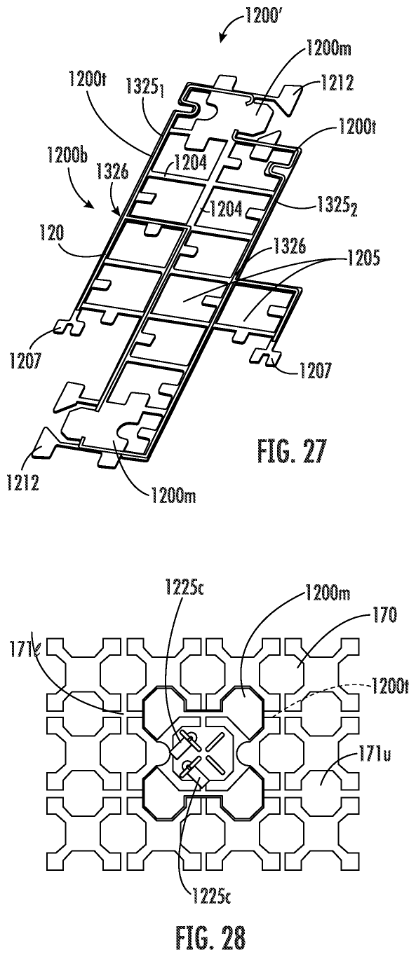

As noted above, the linear segments 1204 can be in-line with metal or metallized linear segments 171l (FIG. 28) of respective unit cells 171u so as to not block or reside over open interior spaces 172 of unit cells 171u of the first and/or the second grid reflector reflectors 170₁, 170₂. This arrangement also acts to form the conductor signal paths 1325₁, 1325₂ as microstrip transmission lines since the grid reflector(s) 170 provide the ground plane for the microstrip transmission lines. In some embodiments, one or more of the feed boards 1200′ can be arranged behind the first grid reflector 170₁ and one or more of the feed boards 1200′ can be arranged in front of the first grid reflector 170₁. Where a single grid reflector 170 is used, the feed boards 1200′ can be arranged on both primary surfaces of that grid reflector 170. In such embodiments, a single grid reflector 170₁ may act as the ground plane for feed boards 1200′ that are mounted on both sides of the grid reflector 170₁.

The feed boards 1200′ can be for any radiating elements that operate in any frequency band such as low band radiating elements 222 and/or mid band radiating elements 232.

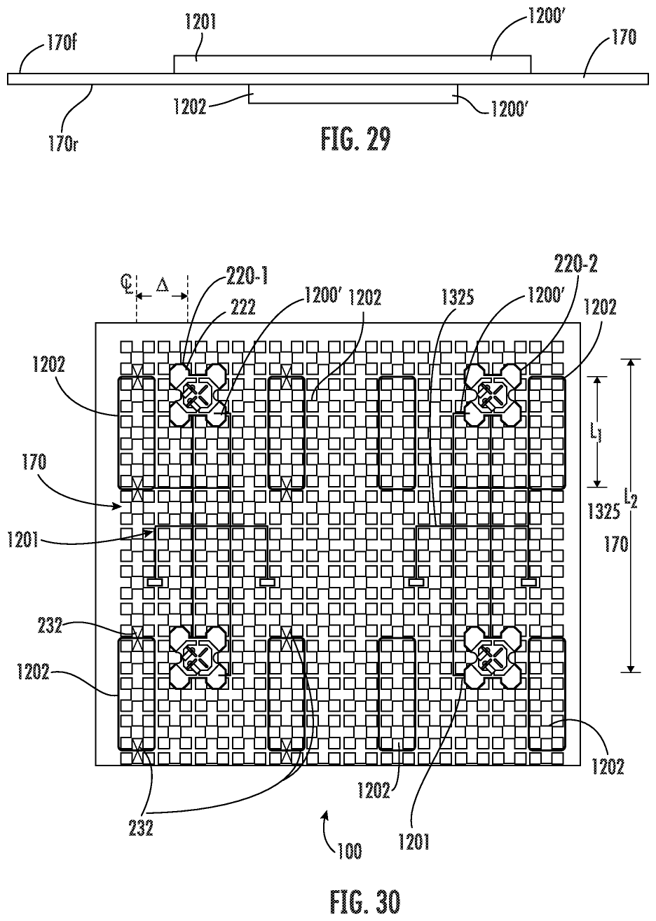

Referring to FIG. 29, some feed boards 1200′ can reside on a front or first primary surface 170f of the grid reflector 170 while other feed boards 1200′ can reside on a second, rear primary surface 170r of the grid reflector 170. The feed boards 1200′ can be arranged so that feed boards 1201 for low band radiating elements 222 are on one of the two primary surfaces, such as the front primary surface 170f, while feed boards 1202 for mid-band radiating elements 232 are on the other, such as the rear primary surface 170r. Alternatively, some feed boards 1201 of the low band radiating elements 222 can reside on or in front of the first primary surface 170f while other feed boards 1201 of the low band radiating elements 222 can reside behind or on the rear primary surface.

FIG. 30 illustrates an example layout of feed boards 1200′ with respect to a grid reflector 170 of a base station antenna 100. As shown, the base station antenna 100 can have a plurality of laterally spaced apart mid band feed boards 1202 arranged in rows and columns behind a plurality of the low band feed boards 1201. Centerlines C/L of the low band feed boards 1201 can be laterally offset a distance Δ from neighboring mid-band feed boards 1202. The mid-band feed boards 1202 can have a smaller longitudinal extent/length dimension L₁ relative to the length L₂ of the low-band feed boards 1201, typically at least 40% less. At least some of the signal traces 1325 and/or feeding cable 1225 of different feed boards 1201 and/or 1202 can cross over/across each other in different planes, some forward of the front primary surface 170f, others behind the rear primary surface 170r.

FIG. 30 shows two low-band feed boards 1201, one on a right side of a base station antenna 100 (or grid reflector 170), each feeding two low band radiators 222, although one or more the feed boards 1201 can be configured to feed more than two low band radiators 222. FIG. 30 also shows a single column of mid-band feed boards 1202 to the left and right of respective left-side and right-side, low band feed boards 1201. FIG. 30 also shows that there can be plurality of mid-band feed boards 1202 positioned laterally between the two linear arrays 220-1, 220-2 of low band radiators 222 and corresponding low band feed boards 1201. Each mid-band feed board 232 can feed two or more mid band radiating elements 232, shown as two.

Turning now to FIGS. 31-34, the feeding (coaxial) cables 1225 can be configured to extend primarily in a length dimension/direction of the grid reflector 170, each can be aligned with a linear metal or metallized segment of the grid reflector 170. The cables 1225 can be routed such that there is between 0-3 short lateral segments 1258 bridging from a feed board 1200′ to a longer longitudinal segment 1259. Any lateral segment 1258 can be relatively short, such as less than 10% of an overall length of a corresponding cable 1225 along the grid reflector 170. This configuration does not require that the cables 1225 be routed across the entire grid reflector 170 from a respective feed board 1200′ which may result in performance degradation. This configuration may be implemented without requiring cross-over jumpers.

Each feed board 1200′ can connect to first and second cables 1225₁, 1225₂, respectively, and to at least first and second radiating elements 222 or 232.

The feed boards 1200′ can be metallized on both primary surfaces thereof and a film such as a dielectric film may be positioned between the grid reflector 170 and the feed boards 1200′. In other cases, only one side of the feed boards 1200′ (the side with the linear segments 1204) may be metallized and a separate grid reflector 170 may serve as the ground plane.

Some feed boards 1200′ may reside on the front primary surface 170f and some on the rear primary surface 170r, allowing for increased density of cables residing in different planes.

Turning again to FIG. 25, the grid reflector 170 can comprise first and second grid reflectors 170₁, 170₂ that are stacked, spaced apart in a front-to-back direction and each can have an array of unit cells 171u. The array of unit cells 171u of one or both of the first and second grid reflectors 170₁, 170₂ can be configured to absorb, block and/or reflect at least one of RF energy in a first frequency band and/or RF energy in a second frequency band, and pass RF energy in a third frequency band where the third frequency band encompasses frequencies between the first and second frequency bands.

Still referring to FIG. 25, the grid reflector(s) 170 can have right and left sides 170s that project forward at an oblique angle in a Z-dimension. The right and left sides 170s can define side walls 170w and each of the side walls 170w comprises unit cells 171u the grid reflector.

The unit cell pattern 171 of unit cells 171u can change across and/or along the reflector 170. For example, a first pattern can reside behind the mid-band radiators 232 and a second different pattern can reside behind the low band radiators 222 and each pattern can be configured to reflect radio frequency energy from the corresponding radiators positioned thereat while each allows high band energy from high band radiators 1195 positioned behind the grid reflector 170 to propagate therethrough.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.)

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The term “about” used with respect to a number refers to a variation of +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A base station antenna, comprising:
a grid reflector comprising an array of unit cells; and
a feed board coupled to the grid reflector, wherein the feed board is configured to replicate at least part of a unit cell structure of one or more of the unit cells of the array of unit cells.

2. The base station antenna of claim 1, wherein the grid reflector comprises a feed board aperture, and wherein the feed board extends across and overlaps a portion of a plurality of unit cells of the array of unit cells that surround the feed board aperture.

3. The base station antenna of claim 1, wherein the feed board comprises metal shapes that replicate at least part of a shape of the unit cell structure, and wherein the metal shapes overlap at least some unit cells of the grid reflector.

4. The base station antenna of claim 1, wherein the feed board is devoid of signal transmission lines on a front primary surface.

5. The base station antenna of claim 1, wherein the feed board comprises a ground layer that occupies only a portion of one primary surface of the feed board and is arranged in at least one curvilinear metal pattern.

6. The base station antenna of claim 1, further comprising a radiating element with a feed stalk, the radiating element projecting forward of the grid reflector, wherein the feed board is coupled to first and second coaxial cables residing adjacent a rear surface of the feed board.

7. The base station antenna of claim 1, wherein the grid reflector is at least partially defined by a metal grid with a pattern of metal unit cells, and wherein the feed board aperture has a perimeter that is surrounded by a plurality of the unit cells.

8. The base station antenna of claim 1, further comprising a plurality of spaced apart feed board apertures that are spaced apart from right and left side segments of the base station antenna, wherein the feed board is arranged as a plurality of spaced apart feed boards, and wherein one feed board of the plurality of feed boards extends across one of the plurality of spaced apart feed board apertures.

9. The base station antenna of claim 1, wherein the array of unit cells is arranged in a repeating pattern that extends across at least a major portion of a lateral dimension of the base station antenna in front an array of radiating elements.

10. The base station antenna of claim 1, wherein the feed board comprises at least one conductive segment that has a curvilinear configuration that matches at least a portion of at least a portion of a structure of a unit cell of the array of unit cells of the grid reflector.

11. The base station antenna of claim 2, wherein the feed board aperture comprises a surface area that is greater than a surface area of a unit cell of the array of unit cells.

12. The base station antenna of claim 1, wherein the grid reflector is defined at least partially by a metal grid.

13. The base station antenna of claim 1, wherein the grid reflector is defined at least partially by a multi-layer printed circuit board.

14. The base station antenna of claim 1, wherein the feed board is devoid of solid, continuous conductive primary surfaces and comprises conductive segments provided in a shape that corresponds to at least a portion of a shape of one or more unit cells of an array of the unit cells.

15. The base station antenna of claim 1, wherein the grid reflector defines a frequency selective surface, and wherein the grid reflector and feed board cooperate to reflect energy in a first frequency band and allow energy from mMIMO radiating elements in a second frequency band that are positioned behind the grid reflector to propagate therethrough.

16. The base station antenna of claim 1, further comprising an active antenna unit coupled to a rear of the base station antenna and residing behind the grid reflector.

17. The base station antenna of claim 1, wherein the feed board has a perimeter shape that matches at least a portion of a perimeter of at least one unit cell of the array of unit cells of the FSS.

18. The base station antenna of claim 1, wherein the feed board has a surface that has a conductive metal pattern that matches a portion of a shape of a unit cell of the array of unit cells.

19. The base station antenna of claim 1, wherein the feed board comprises a portion with a shape that resides over or behind a metal portion of the unit cell having a corresponding shape.

20. A feed board for a radiating element, wherein the feed board has first and second opposing primary surfaces and a ground layer on only one of the first and second primary surfaces, and wherein the feed board is devoid of signal transmission lines on either of the first and second primary surfaces.

21. The feed board of claim 21, wherein the ground layer that occupies only a portion of the first or second primary surface of the feed board and is arranged in at least one curvilinear metal pattern.

22. A base station antenna comprising:
a grid reflector with an array of metal patches or metal shapes; and
a feed board comprising spaced apart metallized shapes, wherein at least one of the metallized shapes of the feed board overlaps with at least one of the metal patches or metal shapes of the grid reflector.

23-33. (canceled)

34. A base station antenna, comprising:
a grid reflector; and
a plurality of feed boards coupled to the grid reflector, wherein some of the feed boards reside on a front primary surface of the grid reflector and some of the plurality of feed boards reside on a rear primary surface of the grid reflector.

35-44. (canceled)

45. A base station antenna, comprising:
a grid reflector; and
a plurality of feed boards coupled to the grid reflector, wherein at least some of the plurality of feed boards have a lattice body with apertures surrounded by metal linear segments defining at least first and second conductive signal traces.

46-55. (canceled)
